(19) United States
(12) Patent Application Publication
(10) Pub. No.: US 2016/0189887 A1
(43) Pub. Date: Jun. 30, 2016

(54) BIDIRECTIONALLY BLOCKING ELECTRONIC SWITCH ARRANGEMENT

(71) Applicant: Infineon Technologies Austria AG, Villach (AT)

(72) Inventors: Rolf Weis, Dresden (DE); Anton Mauder, Kolbermoor (DE); Franz Hirler, Isen (DE)

(21) Appl. No.: 14/587,375

(22) Filed: Dec. 31, 2014

(51) Int. Cl. H01H 9/54

(52) U.S. Cl. CPC H01H 9/54

(57) ABSTRACT

An electronic circuit includes first and second electronic switches each having a load path and a control node, a plurality of switch units each having a load path between a first load node and a second load node, and a plurality of drive units. The load paths of the electronic switches and switch units are connected in series to form a load path of the electronic circuit. A series circuit with the load paths of the switch units is connected between the load paths of the electronic switches. The load path of the electronic circuit includes a plurality of taps. Each drive unit is associated with one of the switch units, is coupled to at least two different taps of the plurality of taps, and is configured to drive the associated switch unit based on an electrical potential at one of the at least two different taps.

### TECHNICAL FIELD

Embodiments of the present invention relate to a circuit arrangement, in particular a circuit arrangement that can be used as a bidirectionally blocking electronic switch.

### BACKGROUND

Transistor devices, such as MOSFETs, are widely used as electronic switches in various types of electrical applications, such as drive applications, power conversion applications, household applications, or consumer electronic applications. A MOSFET is a voltage controlled device that switches on and off dependent on a drive voltage applied to a gate terminal. However, a conventional power MOSFET, that is a MOSFET that is suitable for switching electrical loads, includes an internal diode (usually referred to as body diode) that can be forward biased independent of the drive voltage. For example, in an n-type MOSFET, the body diode conducts independent of the drive voltage whenever a positive voltage is applied between a source terminal and a drain terminal of the MOSFET. When the body diode is reverse biased, the MOSFET switches on and off dependent on the drive voltage. Thus, a conventional MOSFET is only capable to switch on and off when a voltage with a first polarity is applied between the drain and source terminals, while it always conducts when a voltage with a second polarity opposite the first polarity is applied between the drain and source terminals.

However, there are applications where it is desirable to have a bidirectionally blocking electronic switch, that is, an electronic switch which, in an off-state, is capable of blocking voltages with a first polarity and an opposite second polarity. Examples of those applications include matrix inverters, battery switches in cars, and the like.

### SUMMARY

One embodiment relates to an electronic circuit. The electronic circuit includes a first electronic switch including a load path and a control node, a second electronic switch including a load path and a control node, and a plurality of switch units, each including a load path between a first load node and a second load node, and a plurality of drive units. The load path of the first electronic switch, the load path of the second electronic switch, and the load paths of the plurality of switch units are connected in series to form a load path of the electronic circuit. A series circuit with the load paths of the plurality of switch units is connected between the load path of the first electronic switch and the load path of the second electronic switch. The load path of the electronic circuit comprises a plurality of taps, and each drive unit is associated with one of the plurality of switch units, is coupled to two different taps of the plurality of taps, and is configured to drive the associated switch unit based on an electrical potential at one of the two different taps.

Those skilled in the art will recognize additional features and advantages upon reading the following detailed description, and upon viewing the accompanying drawings.

### BRIEF DESCRIPTION OF THE DRAWINGS

Examples are explained herein with reference to the drawings. The drawings serve to illustrate the basic principle, so that only aspects necessary for understanding the basic principle are illustrated. The drawings are not to scale. In the drawings the same reference characters denote like features.

FIG. 1 illustrates a first embodiment of an electronic circuit including a first electronic switch, a second electronic switch, and a plurality of the switch units;

FIG. 2 illustrates use of the electronic circuit as an electronic switch;

FIGS. 3A-3B schematically illustrate electrical potentials at taps of a load path of the electronic circuit in an off-state (FIG. 3A), and an on-state (FIG. 3B) of the electronic circuit;

FIGS. 4A-4B schematically illustrate electrical potentials at taps of a load path of the electronic circuit in an off-state (FIG. 4A), and an on-state (FIG. 4B) of the electronic circuit;

FIG. 5 illustrates one embodiment of an electronic circuit implemented with one third transistor in each switch unit;

FIG. 6 illustrates one embodiment of a drive unit configured to drive one switch unit;

FIGS. 7A-7B show characteristic curves of a semiconductor device implemented in the drive unit shown in FIG. 6;

FIG. 8 illustrates another embodiment of one drive unit configured to drive one switch unit;

FIG. 9 illustrates a vertical cross sectional view of one embodiment of a third transistor;

FIG. 10 illustrates a vertical cross sectional view of another embodiment of one third transistor;

FIG. 11 illustrates a switch unit and a corresponding drive unit according to another embodiment;

FIG. 12 shows one embodiment of the drive unit shown in FIG. 10 in greater detail;

FIG. 13 illustrates one embodiment of a switch unit including one third transistor and one fourth transistor, and one embodiment of a corresponding drive unit;

FIG. 14 shows two switch units of the type illustrated in FIG. 13 connected in series;

FIGS. 15A-15C show two vertical cross sectional views and a horizontal cross sectional view, respectively, of one embodiment of a third transistor and a fourth transistor;

FIG. 16 shows a vertical cross sectional view of the semiconductor body shown in FIG. 15B in section plane perpendicular to the section plain shown in FIG. 15A;

FIG. 17 illustrates implementing a first electronic switch, a second electronic switch and a plurality of switch units each including a third electronic switch and a fourth electronic switch in one semiconductor body;

FIGS. 18A-18C show a third electronic switch and a fourth electronic switch according to another embodiment;

FIG. 19 shows a horizontal cross sectional view of the semiconductor body shown in FIG. 18A;

FIGS. 20A-20B illustrate a further embodiment of a third electronic switch and a fourth electronic switch integrated in one semiconductor body;

FIGS. 21A-21B shows a vertical cross sectional view of a semiconductor body that includes a dielectric well for integrating a drive unit in the same semiconductor body as a switch unit;

FIGS. 22A-22F illustrate one embodiment of a method for forming a dielectric well; and

FIG. 23 shows a dielectric well according to another embodiment.

### DETAILED DESCRIPTION

In the following detailed description, reference is made to the accompanying drawings. The drawings form a part of the description and by way of illustration show specific embodiments in which the invention may be practiced. It is to be understood that the features of the various embodiments described herein may be combined with each other, unless specifically noted otherwise.

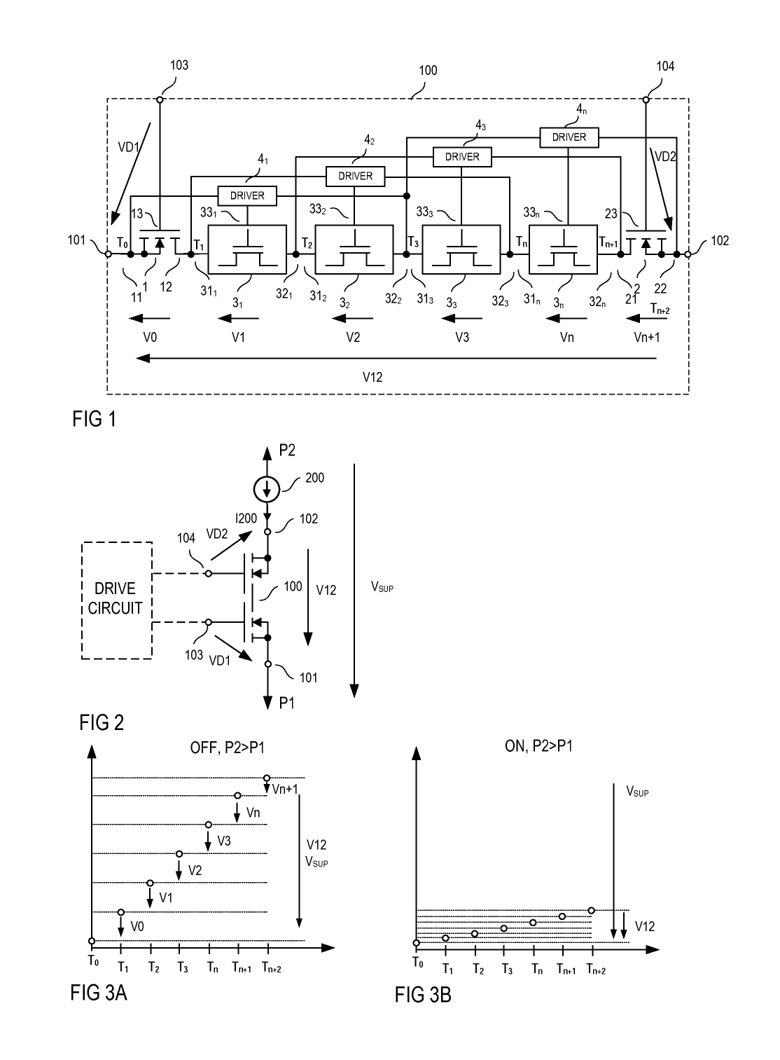

FIG. 1 illustrates one embodiment of an electronic circuit 100 that can be used as a bidirectionaly blocking electronic switch. The electronic circuit includes a first electronic switch 100 having a load path between a first load node 11 and a second load node 12, and a control node. The electronic circuit further includes a second electronic switch 2 having a load path between a first load node 21 and a second load node 22, and a control node 23. The electronic circuit further includes a plurality of switch units 3₁, 3₂, 3₃, 3ₙ each including a load path between a first load node 31₁, 31₂, 31₃, 31ₙ and a second load node 32₁, 32₂, 32₃, 32ₙ. The load paths of the first electronic switch 1, the second electronic switch 2 and of the plurality of switch units 3₁-3ₙ are connected in series to form a load path of the electronic circuit 100. In this load path of the electronic circuit 100, a series circuit with the load paths of the plurality of switch units 3₁-3ₙ is connected between the load paths of the first electronic switch 1 and the load paths of the second electronic switch 2. The load path of the electronic switch 100 is connected between a first load node 101 and a second load node 102 of the electronic circuit 100.

Referring to FIG. 1, the electronic circuit 100 further includes a plurality of drive units 4₁, 4₂, 4₃, 4ₙ, wherein each of the plurality of drive units 4₁-4ₙ is associated with one of the plurality of switch units 3₁-3ₙ, and is configured to drive the associated switch unit 3₁-3ₙ. The load path of the electronic circuit 100 includes a plurality of taps T₀, T₁, T₂, T₃, Tₙ, Tₙ₊₁, Tₙ₊₂. In the embodiment shown in FIG. 1, each of these taps T₀-Tₙ₊₂ corresponds to one load node of the first electronic switch 1, the second electronic switch 2, and one of the plurality of switch units 3₁-3ₙ, respectively. In particular, a first tap T₀ corresponds to the first load node 11 of the first electronic switch 1, a second tap T₁ corresponds to the second load node 12 of the first electronic switch 1, and the first load node 31₁ of a first switch unit 3₁, respectively. A (n+1)-th tap Tₙ₊₁ corresponds to the first load node 21 of the second electronic switch 2, and a (n+2)-th tap Tₙ₊₂ corresponds to the second load node 22 of the second electronic switch 2. The other taps T₂-Tₙ correspond to the first load nodes 31₂, 31₃, 31ₙ of a second switch unit 3₂, a third switch unit 3₃, and an n-th switch unit 3ₙ, respectively. These taps T₂, T₃, Tₙ further correspond to second load nodes 32₁, 32₂, 32₃ of the first switch unit 3₁, the second switch unit 3₂, and the third switch unit 3₃, respectively.

Referring to FIG. 1, the load paths of the first electronic switch 1, the second electronic switch 2, and the plurality of switch units 3₁, 3ₙ form a cascode circuit such that the load path of the first electronic switch 1 is directly connected to the first load node 101 of the electronic circuit 100, the load path of the second electronic switch 2 is directly connected to the second load node 102 of the electronic circuit 100, the load path of the first switch unit 3₁ is directly connected to the load path of the first electronic switch 1, the load path of the n-th switch unit 3ₙ is directly connected to the load path of the second electronic switch 2, and the load paths of each of the other switch units 3₂, 3₃ (in general, 3ₙ₋₁) are directly connected between load paths of two other switch units. In the embodiment shown in FIG. 1, the electronic circuit 100 includes n=4 switch units 3₁-3ₙ. However, this is only an example. The number n of switch units 3₁-3ₙ is arbitrary. The electronic circuit may be implemented with more than n=4 switch units 3₁-3ₙ, but may also be implemented with less than four switch units. It is even possible to implement the electronic circuit with only switch unit.

Referring to FIG. 1, according to one embodiment, each drive unit 4₁-4ₙ is coupled to two different taps of the plurality of taps T₀-Tₙ₊₂ of the load path, the two different taps each of the plurality of drive units 4₁-4ₙ is connected to are different from the load nodes of the associated switch unit. For example, a first drive unit 4₁ which is associated with the first switch unit 3₁ is connected to taps T₀, T₃. These taps T₀, T₃ are different from taps T₁, T₂ which are formed by the first load node 31₁ and the second load node 32₁ of the switch unit 3₁ associated with the drive unit 4₁. Further, each drive unit 4₁-4ₙ is configured to drive the associated switch unit 3₁-3ₙ based on an electrical potential at one of the two different taps it is connected to. This is explained in further detail herein below.

The individual drive units 4₁-4ₙ may be connected to the taps T₀-Tₙ₊₂ of the load path in different ways. In the following, a denotes any one of the plurality of switch units 3₁-3ₙ, and 31ᵢ, 32ᵢ denote the first and second load nodes of this switch unit 3ᵢ. In the embodiment shown in FIG. 1, each drive unit 3ᵢ has two neighbors, wherein a neighbor can be the first electronic switch 1, the second electronic switch 2, or another one of the plurality of switch units 3₁-3ₙ. In the following, a first neighbor (left neighbor) is the neighbor connected to the first load node 31ᵢ of the respective switch unit 3ᵢ, and a second neighbor (right neighbor) is the neighbor connected to the second load node 32ᵢ of the respective switch unit 3ᵢ. For example, the first electronic switch 1 is the first neighbor of the first switch unit 3₁, and the second switch unit 3₂ is the second neighbor of the first switch unit 3₁. According to the embodiment shown in FIG. 1, each drive unit 4ᵢ is connected to one tap that is separated from the first load node 31ᵢ of the associated switch unit 3ᵢ by the load path of the first neighbor, and is connected to another tap which is separated from the second load node 32ᵢ of the associated switch unit 3ᵢ by the load path of the second neighbor. For example, the drive unit 4₁ associated with the switch unit 3₁ is connected to the tap T₀ which is separated from the first load node 31₁ of the switch unit 3₁ by the load path of the first electronic switch 1 (the first neighbor), and to the tap T₃ which is separated from the second load node 32₁ by the load path of the second neighbor (right neighbor) 3₂. Further, for example, driver 4₃ which is associated with the switch unit 3₃ is connected to the tap T₂ which is separated from the first load node 31₃ of the associated switch unit 3₃ by the load path of the switch unit 3₂ (first neighbor), and to the tap Tₙ₊₁ which is separated from the second load node 32₃ by the load path of the switch unit 3ₙ (second neighbor).

Each of the drive units 4₁-4ₙ is configured to drive the associated switch unit 3₁-3ₙ based on the electrical potential at one of the two different taps it is connected to. This is explained by way of examples with reference to further embodiments herein below.

Referring to FIG. 1, each of the first electronic switch 1 and the second electronic switch 2 further includes a control node 13, 23. The control node 13 of the first electronic switch 1 forms a first control node 103 of the electronic circuit 100, and the control node 23 of the second electronic switch 2 forms a second control node 104 of the electronic circuit 100. According to one embodiment each of the first electronic switch 1 and the second electronic switch 2 is a unidirectional electronic switch. That is, each of these switches 1, 2 is configured to only block a voltage of one polarity, while it always conducts when a voltage of an opposite polarity is applied thereto. In the embodiment shown in FIG. 1, each of the first electronic switch 1, and the second electronic switch 2 is implemented as a MOSFET. A MOSFET is a voltage-controlled semiconductor device which includes an internal diode (body diode) that can be forward biased independent of a drive voltage (gate-source-voltage). For example, in an n-type MOSFET the body diode conducts independent of the drive voltage whenever a positive voltage is applied between a source terminal and a drain terminal of the MOSFET. And when the body diode is reversed biased, the MOSFET switches on and off dependent on the drive voltage. In the embodiment shown in FIG. 1, the first electronic switch 1 and the second electronic switch 2 are each implemented as an n-type MOSFET. These MOSFETs 1, 2 are connected in the series circuit (the cascode circuit) such that the internal body diodes of the two MOSFETs 1, 2 are connected back-to-back. In the present example, the first load node 11 of the first electronic switch 1 corresponds to the source node of the respective MOSFET, and the second load node 22 of the second electronic switch 2 corresponds to the source node of the respective MOSFET. Consequently, the second load node 12 of the first electronic switch 1 corresponds to the drain node of the respective MOSFET, and the first load node 21 of the second electronic switch 2 corresponds to the drain node of the respective MOSFET. The control nodes 13, 23 of the first and second electronic switches 1, 2 are the gate nodes of the respective MOSFETs.

To implement each of the first and second electronic switch 1, 2 as an n-type MOSFET is only an example. It is also possible, to implement each of the first and second electronic switches 1, 2 as a p-type MOSFET. Further, it is also possible, to implement one of the first and second electronic switch 2 as an n-type MOSFET, and the other one of the first and second electronic switch 2 as a p-type MOSFET. However, in each of these embodiments, the MOSFETs forming the first electronic switch 1 and the second electronic switch 2, respectively, have their load paths connected in the cascode circuit such that the respective body diodes are connected back-to-back (with the load paths of the drive units 3₁-3ₙ connected therebetween).

Basically, a cascode circuit which includes two MOSFETs connected in series such that the internal body diodes are connected back-to-back forms a bidirectionally blocking electronic switch. The voltage blocking capability of this electronic switch corresponds to the voltage blocking capability of one of the two MOSFETs, namely the one of the two MOSFETs which has its body diode reverse biased by the blocking voltage. In the electronic circuit 100 according to FIG. 1, by virtue of the plurality of switch units 3₁-3ₙ, the overall voltage blocking capability is higher than the voltage blocking capability of one of the first and second electronic switches 1, 2. The voltage blocking capability of the electronic circuit 100 can be increased by increasing the number of switch units 3₁-3ₙ connected in series.

The electronic circuit 100 shown in FIG. 1 can be used as an electronic switch. This is explained with reference to FIG. 2 below. FIG. 2 shows a circuit symbol representing the electronic circuit 100 with the first and second control nodes 103, 104 and the first and second load nodes 101, 102. In the example shown in FIG. 2, a load implemented as a current source 200 is connected in series with the load path (the path internally running between the first load node 101 and the second load node 102) of the electronic circuit 100) in order to illustrate operation of the electronic circuit. In the example, the series circuit with electronic circuit 100 (which may also be referred to as electronic switch) and the current source 200 is connected between a first supply node where a first electrical potential P1 is available, and a second supply node where a second electrical potential P2 is available.

The electronic switch 100 shown in FIG. 2 can be subject to two different supply modes, and can assume two different switching modes in each of these two supply modes. In a first supply mode, the first electrical potential P1 is lower than the second electrical potential P2 (P2>P1), so that a supply voltage V_{SUP} has a polarity as shown in FIG. 2, and the current source 200 is configured to drive a current I200 in the direction as indicated in FIG. 2. The “supply voltage” is the voltage between the second supply node and the first supply node.

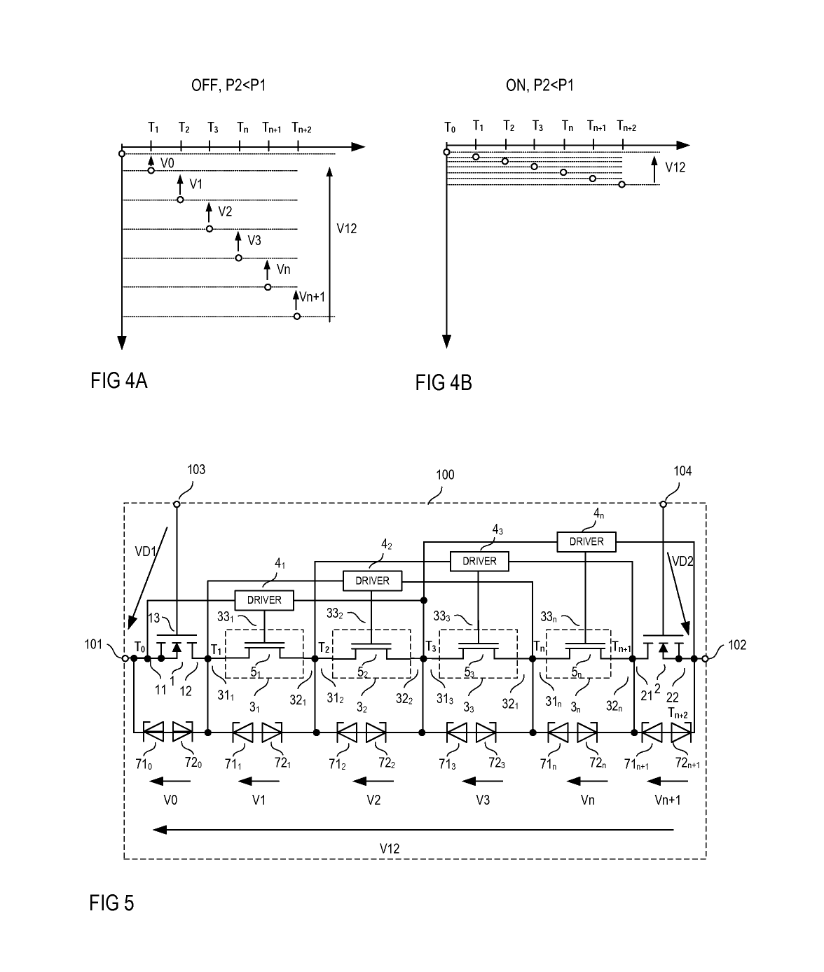

In a second supply mode, the second electrical potential P2 is lower than the first electrical potential P1 (P2<P1), so that the supply voltage V_{SUP} has a polarity opposite the polarity shown in FIG. 2, and the current source 200 is configured to drive a current I200 in a direction opposite the direction indicated in FIG. 2. In an on-state, the electronic circuit (switch) 100 allows the current I200 to flow through the electronic switch 100, and in an off-state, the electronic circuit 100 blocks. In the on-state, a load path voltage V12, which is the voltage between the second load node 102 and the first load 101, is significantly below the supply voltage V_{SUP}, while in the off-state, the load-path voltage V12 substantially corresponds to the supply voltage V_{SUP}. Summarizing the above, there are four different operation modes of the electronic switch 100. These operation modes are explained with reference to FIGS. 3A-3B, and 4A-4B, below.

FIGS. 3A and 3B illustrate the operation of the electronic switch 100 in the first supply mode (P2>P1). In particular, FIG. 3A illustrates the electrical potentials at the taps T₀-Tₙ₊₂ of the electronic switch 100 in the off-state, and FIG. 3B, illustrates the electrical potentials at the taps T₀-Tₙ₊₂ in the on-state of the electronic circuit 100. Referring to FIG. 3A, in the off-state, the load-path voltage V12 of the electronic switch 100 substantially corresponds to the supply voltage V_{SUP}. The load-path voltage V12 is the sum of the load path voltages V₀ of the first electrode switch 1, Vₙ₊₁ of the second electronic switch 2, and V₁ . . . Vₙ of the switch units 3₁-3ₙ, that is:

V12=ΣᵢVᵢ (1)

In the embodiment shown in FIG. 1, the load-path voltage of each of the elements 1, 2, 3₁-3ₙ forming the load path of the electronic switch 100 corresponds to the difference of the electrical potentials of two neighboring taps. In the first supply mode, the electrical potential, beginning at tap T₀, increases from tap to tap. In this operation mode, the first electronic switch 1 and each of the switch units 3₁-3ₙ is blocking, while the second electronic switch 2 is conducting. The levels of the load-path voltages of the first electronic switch 1 and of the switch units 3₁-3ₙ are dependent on different parameters that are explained further below.

In the on-state of the electronic circuit 100, each of the first and second electronic switches 1, 2, and each of the switch units 3₁-3ₙ is conducting. Consequently, the load path voltages of the first electronic switch 1, and of each of the switch units 3₁-3ₙ are lower than in the off-state (see FIG. 3A). Thus, referring to FIG. 3B, the overall load-path voltage V12 is significantly below the supply voltage V_{SUP}.

In the first supply mode, the operation mode of the electronic circuit 100 corresponds to the operation mode of the first electronic switch 1. That is, the electronic circuit 100 is in the on-state, when the first electronic switch 1 is switched on, and the electronic circuit 100 is in the off-state, when the first electronic switch 1 is switched off. The first electronic switch 1 is configured to switch on and off based on a drive voltage VD1 received between the control node 13 and the first load node 11 (corresponding to the first control node 103 and the first load node 101 of the electronic circuit 100). In case the electronic switch 1 is implemented as a MOSFET (as shown in FIG. 1) it can be switched on and off like a conventional MOSFET. That is, it switches on when the drive voltage VD1 is higher than a threshold voltage, and it switches off when the drive voltage VD1 is below the threshold voltage. The first electronic switch 1 can be implemented as a normally-off MOSFET (enhancement MOSFET) as illustrated in FIG. 1. However, it is also possible to implement the first electronic switch 1 as a normally-on MOSFET (depletion MOSFET). A conventional drive circuit for driving a MOSFET can be used to supply the drive voltage VD1 to the electronic switch 1. This drive voltage VD1 will be referred to as first drive voltage in the following. In the first supply mode, the operation mode of the electronic circuit 100 is independent of a drive voltage VD2 between the second control node 104 and the second load node 102 received by the second electronic switch 2. This drive voltage VD2 will be referred to as second drive voltage in the following.

Referring to FIGS. 4A-4B, operation of the electronic switch 100 in the second supply mode (P1>P2) is similar to the operation in the first supply mode (P2>P1), with the difference that in the second supply mode the load-path voltage V12 of the electronic switch 100 and the load-path voltages V0 . . . Vn+1 of the individual load path elements 1, 2, 3₁-3ₙ have a polarity opposite the polarity in the first supply mode. Further, in the second supply mode, the first electronic switch 1 is conducting (by virtue of the internal body diode) independent of the first drive voltage VD1. In this second supply mode, the operation mode of the electronic circuit 100 follows the operation mode of the second electronic switch 2. That is, the electronic circuit 100 is in the on-state when the second electronic switch 2 is switched on, and the electronic circuit 100 is in the off-state when the second electronic switch 2 is switched off. The second electronic switch 2 switches on and off dependent on the level of the second drive voltage VD2 received between the control node 23 and the second load node 22 (which are the gate node and the source node in case of a MOSFET).

FIG. 5 illustrates one embodiment of an electronic circuit 100 in which the switch units 3₁-3ₙ each include one transistor 5₁-5ₙ. These transistors 5₁-5ₙ will be referred to as third transistors in the following. In the following, 5ᵢ denotes an arbitrary one of these third transistors 5₁-5ₙ, and 4ᵢ denotes the drive unit associated with the switch unit 3ᵢ which includes the third transistor 5ᵢ. Referring to FIG. 5, each of the third transistors 5ᵢ includes a load-path connected between the first load node 31ᵢ and the second load node 32ᵢ of the respective switch unit 3ᵢ. Further, each third transistor 5ᵢ includes a control node coupled to the respective drive unit 4ᵢ. According to one embodiment, the third transistors 5ᵢ are implemented as normally-on transistors. Examples of those normally-on transistors include, but are not restricted to, depletion MOSFETs, JFETs (Junction Field Effect Transistors), HEMTs (High Electron Mobility Transistors), nanotubes or the like.

Optionally, a voltage limiting circuit is connected in parallel with the load-path of each of the load-path elements 1, 2, 3₁-3ₙ. In the embodiment shown in FIG. 5, each voltage limiting circuit includes two Zener diodes 71₀-71ₙ₊₁, 72₀-72ₙ₊₁ which are connected back-to-back. These voltage limiting circuits may also be provided in the embodiment shown in FIG. 1 and in each of the other embodiments explained below. The individual voltage limiting circuits serve to limit the voltage across the load paths of the individual load path elements 1, 2, 3₁-3ₙ.

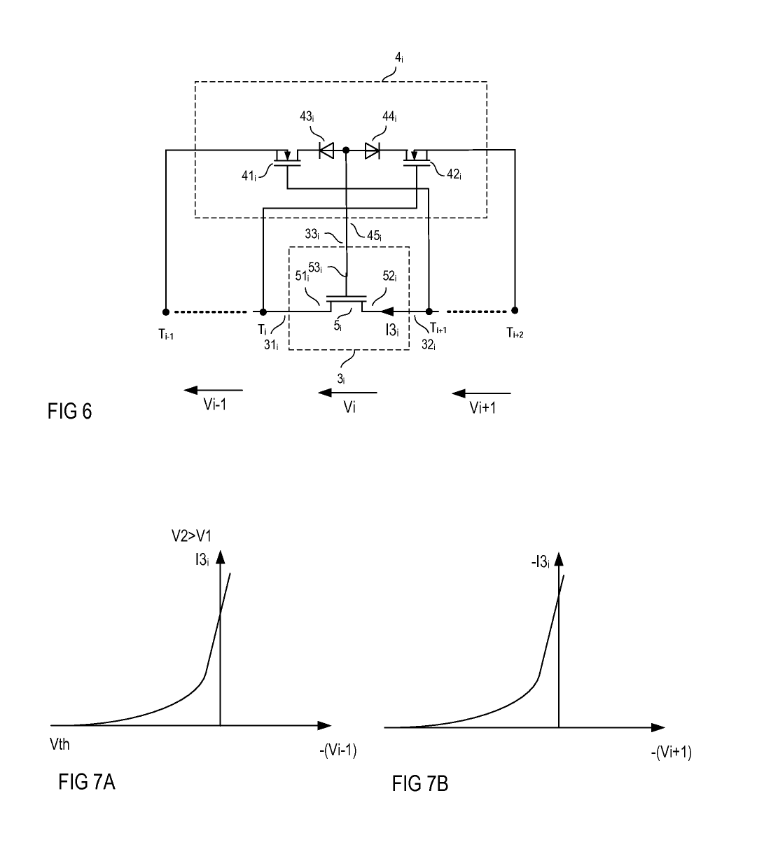

FIG. 6 shows one embodiment of a drive unit 4ᵢ which is suitable to drive a switch unit 3ᵢ implemented with a third transistor 5ᵢ. 3ᵢ denotes an arbitrary one of the plurality of switch units 3₁-3ₙ explained before, and 4ᵢ denotes the drive unit associated with the switch unit 3ᵢ. Further, 51ᵢ denotes a first load node of the third transistor 5ᵢ, and 52ᵢ denotes a second load node of the third transistor 5ᵢ. The first load node 51ᵢ is connected to the first load node 31ᵢ of the switch unit 3ᵢ, and the second load node 52ᵢ is connected to the second load node 32ᵢ of the switch unit 3ᵢ. Further, a control node 53ᵢ of the third transistor 5ᵢ is connected to a control node 33ᵢ of the switch unit 3ᵢ. The drive unit 4ᵢ includes a drive output which is connected to the control node 33ᵢ of the switch unit 3ᵢ in order to drive the switch unit 3ᵢ. Referring to the above, the drive unit 4ᵢ is connected to two different taps of the load path. These two different taps are labeled as Tᵢ₋₁ and Tᵢ₊₂ in FIG. 6.

Referring to FIG. 6, the drive unit 4ᵢ includes a first drive transistor 41ᵢ in series to a first diode 43i, and a second drive transistor 42ᵢ in series to a second diode 44i. A load path of the first drive transistor 41ᵢ is connected between the first tap Tᵢ₋₁ and, via the diode 43ᵢ, the drive output 45ᵢ, and a load path of the second drive transistor 42ᵢ is connected between the second tap Tᵢ₊₂ and, via the diode 44ᵢ, the drive output 45ᵢ. Further, the first drive transistor 41ᵢ is connected such that a drive voltage of the first transistor 41ᵢ corresponds to the load-path voltage Vᵢ of the switch unit 3ᵢ plus the load-path voltage Vᵢ₋₁ of the first neighbor. For this, a control node of the first drive transistor 41 is connected to the second load node 32ᵢ of the switch unit 3ᵢ. The second drive transistor 42ᵢ receives as a drive voltage the negative load-path voltage (−Vᵢ) of the switch unit 3ᵢ plus the negative load-path voltage (−Vᵢ₊₁) of the second neighbor. For this, a control node of the second drive transistor 42ᵢ is connected to the first load node 31ᵢ of the switch unit 3ᵢ.

Having the control node of the first drive transistor 41ᵢ connected to the second load node 32ᵢ of the switch unit 3ᵢ, and having the control node of the second drive transistor 42ᵢ connected to the first load node 31ᵢ of the switch unit 3ᵢ is only an example. According to another embodiment (not shown), the control node of the first drive transistor 41ᵢ is connected to the first tap Tᵢ₋₁ and the control node of the second drive transistor 42ᵢ is connected to the second tap Tᵢ₊₂.

In the embodiment shown in FIG. 6, the first drive transistor 41ᵢ, and the second drive transistor 42ᵢ are each implemented as n-type depletion MOSFET. In this case, the control nodes of the drive transistors 41ᵢ, 42ᵢ correspond to gate nodes of these depletion MOSFETs 41ᵢ, 42ᵢ. Further, a source node of the depletion MOSFET forming the first drive transistor 41ᵢ is connected to the first tap Tᵢ₋₁, and the source node of the depletion MOSFET forming the second drive transistor 42ᵢ is connected to the second tap Tᵢ₊₂. Drain nodes of the depletion MOSFETs forming the first drive transistor 41ᵢ, and the second drive transistor 42ᵢ, respectively, are connected to the drive output 45ᵢ of the drive unit 4ᵢ via the first diode 43ᵢ and the second diode 44ᵢ, respectively. The first diode 43ᵢ and the first transistor 41ᵢ are connected such that the first diode 43ᵢ and an internal body diode of the first transistor 41ᵢ are in a back-to-back configuration, and the second diode 44ᵢ and the second transistor 42ᵢ are connected such that the second diode 44ᵢ and an internal body diode of the second transistor 42ᵢ are in a back-to-back configuration.

The drive unit 4ᵢ shown in FIG. 6 is configured to connect the drive output 45ᵢ to the first tap Tᵢ₋₁ in the first supply mode, and is configured to connect the drive output 45ᵢ to the second tap Tᵢ₊₂ in the second supply mode. This is explained in the following. In the first supply mode, the load path voltage Vᵢ of the switch unit 3ᵢ, and load-voltages Vᵢ₋₁, Vᵢ₊₁ of the first and second neighbor, respectively, have polarities as indicated in FIG. 6. These polarities are independent of whether the electronic circuit 100 is in the on-state or in the off-state. Referring to FIGS. 3A-3B, only the levels of the individual load path voltages are different in the on-state and the off-state. As in the first supply mode, voltages Vᵢ and Vᵢ₋₁, which form the drive voltage of the first drive transistor 41ᵢ, have polarities as indicated in FIG. 6, the first drive transistor 41ᵢ receives a positive drive voltage (gate-source voltage) so that the first drive transistor 41ᵢ switches on. According to one embodiment, a threshold voltage of the first drive transistor 41ᵢ is 0 (zero), so that any positive drive voltage switches on the first transistor 41ᵢ, and any negative drive voltage switches off the first transistor 41ᵢ. In the first supply mode, the drive voltage of the second transistor 42ᵢ is negative (because the voltages Vᵢ and Vᵢ₊₁ have polarities as indicated in FIG. 6), so that the second drive transistor 42ᵢ is switched off in the first supply mode. When implemented as a depletion MOSFET, the second drive transistor 42ᵢ, in the off-state is only capable of blocking a load path voltage with one polarity (which will be referred to as positive load path voltage in the following), while due to the internal body diode the second drive transistor 42ᵢ conducts when the load path voltage has an opposite polarity (which will be referred to as negative load path voltage in the following). The second diode 44ᵢ in series to the load path of the second transistor 42ᵢ helps to prevent a current through the second drive transistor 42ᵢ when the second drive transistor 42ᵢ, is in the off-state and the load path voltage is negative.

In the second supply mode, the load path voltage of the switch unit 3ᵢ, and the load path voltages Vᵢ₋₁, Vᵢ₊₁ of the first and second neighbors have polarities that are opposite to the polarities indicated in FIG. 6, so that in the second supply mode the first drive transistor 41ᵢ receives a negative drive voltage which switches off the first drive transistor 41ᵢ, while the second drive transistor 42ᵢ receives a positive drive voltage which switches on the second drive transistor 42ᵢ. The first diode 43ᵢ connected in series with the load path of the first drive transistor 41ᵢ helps to prevent a current through the first drive transistor 41ᵢ when the first drive transistor 41ᵢ, is in the off-state (switched off) and its load path voltage is negative.

In the first supply mode, when the first drive transistor 41ᵢ couples the drive output 45ᵢ to the first tap Tᵢ₋₁, a drive voltage of the switch unit 3ᵢ and the third transistor 5ᵢ, respectively, corresponds substantially to the load path voltage of the first neighbor. Equivalently, in the second supply mode, when the second drive transistor 42ᵢ couples the drive output 45ᵢ to the second tap Tᵢ₊₂, the drive voltage of the switch unit 3ᵢ corresponds substantially to the load path voltage Vᵢ₊₁ of the second neighbor. More precisely, in the first supply mode, the switch unit 3ᵢ receives as a drive voltage the negative load path voltage −(Vi−1) of the first neighbor, and in the second supply mode, receives the negative load path voltage −(Vi+1) of the second neighbor. Whether the switch unit 3ᵢ is in the on-state or the off-state is depend on the magnitude of the respective drive voltage. According to one embodiment, the third transistor 5ᵢ is implemented such that, in the first supply mode, it switches on when the drive voltage −(Vi−1) is above a (negative) threshold voltage Vth. The third transistor 5ᵢ is in the off-state, when the drive voltage (Vi−1) is below the negative drive voltage Vth. This is schematically illustrated in FIG. 7A which illustrates the characteristic curve of the third transistor 5ᵢ in the first supply mode.

FIG. 7A shows the current I3ᵢ through the switch unit 3ᵢ and the third transistor 5ᵢ respectively, dependent on the drive voltage −(Vi−1). Thus, the switch unit 3ᵢ is in the on-state, when the load path voltage Vi−1 of the first neighbor is above a voltage level which corresponds to the inverted threshold voltage (−Vth). Consequently, the switch unit 3ᵢ is in the off-state, when the voltage level of the load path voltage Vi−1 of the first neighbor is below the inverted threshold voltage (−Vth). Thus the load path voltage of the first neighbor is dependent on the operation mode of the first neighbor. The operation mode of the switch unit 3ᵢ is dependent on the operation mode of the first neighbor. This is explained with reference to FIG. 5 below. For the purpose of explanation it is assumed that the electronic circuit 100 shown in FIG. 5 is in the first supply mode, so that the load path voltage V12 has a polarity as indicated in FIG. 5. Further, it is assumed that first electronic switch 1 is switched off. First switch unit 3₁ receives as a drive voltage the load path voltage V0 of the first electronic switch 1. When the first electronic switch 1 is switched off, the load path voltage V0 is above the negative threshold voltage of the third transistor 5₁ implemented in the first switch unit 3₁, so that the first switch unit 3₁ is in the off-state. The load path voltage V1 of the first switch unit 3₁ is above the negative threshold voltage of the third transistor 5₂ in the second switch unit 3₂ which receives the load path voltage V1 of the first switch unit 3₁ as the drive voltage. Consequently, the second switch unit 3₂ is also in the off-state. Whether only some or all of the switch units 3₁-3ₙ are in the off-state, is dependent on the supply voltage V_{SUP}. If the supply voltage V_{SUP} is relatively low, the first electronic switch 1 and some of the plurality of switch units 3₁-3ₙ may be sufficient to absorb the supply voltage V_{SUP}, while it may be necessary to use the first electronic switch 1 and each of the switch units 3₁-3ₙ to absorb the supply voltage V_{SUP} when the supply voltage V_{SUP} is relatively high. The load path voltages of the first electronic switch 1 and the individual switch units 3₁-3ₙ are limited by the voltage limiting circuits 71₀-71ₙ, 72₀-72ₙ in the embodiment shown in FIG. 5.

When the first electronic switch 1 switches on, the magnitude of load path voltage V0 of the first electronic switch 1 decreases, so that the load path voltage rises to above the negative threshold Vth of the first switch unit 3₁, so that the first switch unit 3₁ switches on. Consequently, the load path voltage V₁ of the first switch unit 3₁ decreases, so that the second switch unit 3₂ switches on, and so on, until the first electronic switch 1 and each of the switch units 3₁, 3ₙ are operated in the on-state. In the on-state, the over-all on-resistance of the electronic circuit 100 corresponds to the sum of the on-resistances of the first electronic switch 1, and the plurality of switch units 3₁-3ₙ. In the first supply mode, the second electronic switch 2, due to the internal body diode, is always conducting. Losses that may occur in the second electronic switch 2 are dependent on whether only the internal body diode of the second electronic switch 2 is conducting, or whether the second electronic switch 2 is also switched on by applying a suitable drive voltage VD2. According to one embodiment, the second electronic switch is switched on in the first supply mode in order to reduce losses that occur in the second electronic switch 2.

The operation of the electronic circuit 100 in the second supply mode (P1>P2) corresponds to the operation in the first supply mode with the difference, that in the second supply mode the first electronic switch 1 is always conducting due to its internal body diode and the second electronic switch governs the switching state of the electronic switch 100. In the second supply mode, the overall load path voltage V12 and the load path voltages V0-Vn+1 of the individual load path elements 1, 2, 3₁-3ₙ have polarities opposite to the polarities indicated in FIG. 5. When the second electronic switch 2 is in the off-state, the load path voltage Vn+1 causes the n-th switch unit 3ₙ to be in the off-state, the load path voltage Vn of the n-th switch unit 3ₙ causes the switch unit 3ₙ₋₁ to be in the off-state, and so on. When the second electronic switch 2 switches on, its load path voltage Vn+1 decreases, which causes the switch unit 3ₙ to switch on. This causes the load path voltage Vn to decrease, so that the switch unit 3ₙ₋₁ switches on, and so on. In the second supply mode, the overall on-resistance of the electronic circuit 100 corresponds to the on-resistance of the second electronic switch 2 plus the on-resistances of the switch units 3₁-3ₙ. When the second electronic switch 2 is switched on, the first electronic switch 1 can additionally be switched on in order to further reduce switching losses that may occur in the first electronic switch 1.

The voltage blocking capability of the electronic circuit 100 is substantially defined by the voltage blocking capabilities of the switch unit 3₁-3ₙ and the voltage limits of the voltage limiting circuits connected in parallel with the load paths of the individual switch unit 3₁-3ₙ.

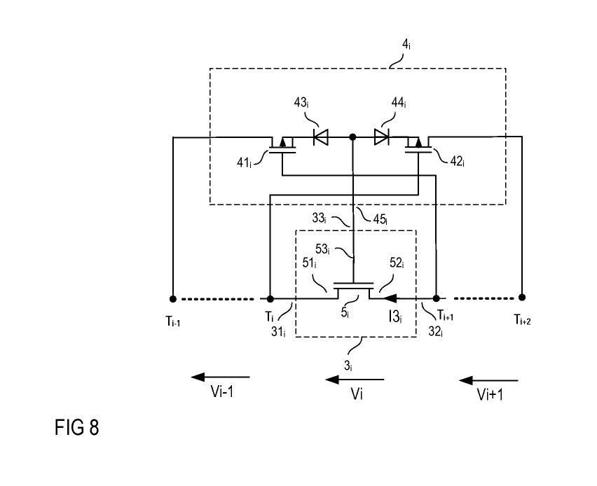

FIG. 8 illustrates a further embodiment of the drive unit 4ᵢ. The drive unit 4ᵢ shown in FIG. 8 is different from the drive unit 4ᵢ shown in FIG. 6 in that the first and second drive transistors 41ᵢ, 42ᵢ shown in FIG. 8 are implemented as p-type depletion MOSFETs. The first and second drive transistors 41ᵢ, 42ᵢ shown in FIG. 8 are connected in the same way as the first and second drive transistors 41ᵢ, 42ᵢ shown in FIG. 6. Like in the embodiment shown in FIG. 6, the first drive transistor 41ᵢ and the first diode 43ᵢ are connected such that the first diode 43ᵢ and an internal body diode of the first drive transistor 41ᵢ are in a back-to-back configuration, and the second drive transistor 42ᵢ and the second diode 44ᵢ are connected such that the second diode 44ᵢ and an internal body diode of the second drive transistor 42ᵢ are in a back-to-back configuration. Thus, the drain node of the first drive transistor 41ᵢ is connected to the tap Tᵢ₋₁, and the drain node of the second drive transistor 42ᵢ is connected to the tap Tᵢ₊₁. Operation of the drive unit 4ᵢ shown in FIG. 8 corresponds to the operation of the drive unit 4ᵢ shown in FIG. 6.

In each of the embodiments shown in FIGS. 6 and 8 the order in which the first and second drive transistor 41ᵢ, 42ᵢ and the first and second diode 43ᵢ, 44ᵢ are arranged between the drive output and the respective tap Tᵢ₋₁, Tᵢ₊₁ can be changed. That is, it is also possible to connect the first diode 43ᵢ between the first transistor 41ᵢ and the first tap To, and to connect the second diode 44ᵢ between the second transistor 42ᵢ and the second tap Tᵢ₊₁.

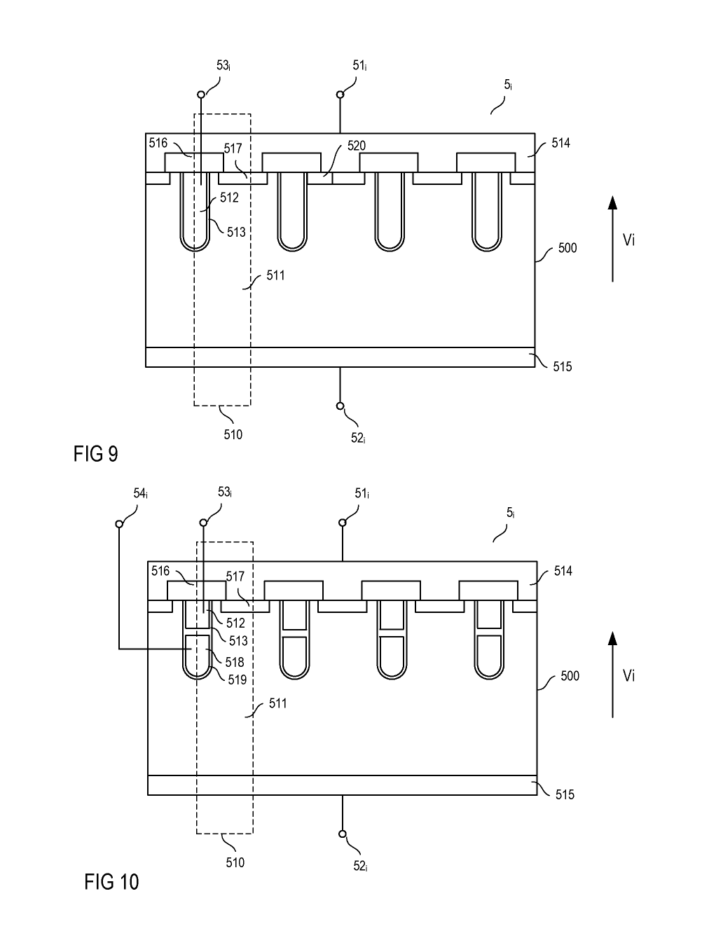

FIG. 9 shows a vertical cross sectional view of a semiconductor body 500 in which a third transistor 5ᵢ implemented as a depletion MOSFETs is integrated. Referring to FIG. 9, the third transistor 5ᵢ includes at least one transistor cell 510 with a source region 517, a drain region 515, and a channel region 511 between the source region 517 and the drain region 515. The transistor cell 510 further includes a gate electrode 512 which is dielectrically insulated from the channel region 511 by a gate dielectric 513. The gate electrode 512 is electrically connected to the control node 53ᵢ of the third transistor 5ᵢ, the source region 517 is connected to the first load node 51ᵢ via a source electrode 514, and the drain region 515 is connected to the second load node (drain node) 52ᵢ. The gate electrode 512 is implemented as a trench electrode in this embodiment. That is, the gate electrode 512 is arranged in a trench which extends from a surface of the semiconductor body 500 into the semiconductor body 500.

The third transistor 5ᵢ shown in FIG. 9 can be switched on and off dependent on the electrical potential of the gate electrode 512. For the purpose of explanation it is assumed that the third transistor 5ᵢ shown in FIG. 9 is an n-type transistor. That is, the source and drain region 517, 515 and the channel region 511 are n-doped semiconductor regions. In this case, the third transistor 5ᵢ is in the off-state, when the gate electrode 512 has an electrical potential relative to the electrical potential of the source region 517 and the drain region 515, respectively, that causes the channel region 511 adjacent the gate dielectric 513 to be depleted.

According to one embodiment, the third transistor 5ᵢ includes a plurality of transistor cells 510. These transistor cells are connected in parallel by having the gate electrodes 512 connected to the control node 53ᵢ, by having the source regions 517 connected to the first load node 51ᵢ, and by having the drain regions 515 connected to the second load node 52ᵢ. According to one embodiment (shown in FIG. 9) the individual transistor cells share the channel region 511 and the drain region 515. The source regions 517 are arranged in mesa region between neighboring (adjacent) gate electrodes. In this embodiment, the third transistor is in the off-state when a drive potential applied to the gate electrodes of the individual transistor cells is such that the mesa regions between the gate electrodes and below the source regions 517 are depleted of charge carriers.

By parasitic effects, such as a leakage current or thermally generated charge carrier pairs, minority charge carriers may be generated in the channel region 511. Minority charge carriers are charge carriers of a type complementary to the doping type of the channel region. If, for example, the channel region is n-doped those charge carriers are p-type charge carriers (holes). In order to prevent these minority charge carriers from accumulating in the mesa regions below the source regions 517 the third transistor optionally includes at least one semiconductor region 520 of a doping type complementary to the doping type of the source and channel regions 517, 511. This semiconductor region 520 is connected to the source electrode 514. Although only one such semiconductor region 520 is shown in FIG. 9, more than one such semiconductor region 520 may be implemented. According to one embodiment, a semiconductor region 520 of a doping type complementary to the doping type of the channel region is implemented in each of the mesa regions.

FIG. 10 illustrates a third transistor 5ᵢ according to another embodiment. The transistor shown in FIG. 10 is based on the transistor shown in FIG. 9, wherein in the embodiment shown in FIG. 10 the at least one transistor cell 510, additionally to the gate electrode 512 and the gate dielectric 513, includes a field electrode 518 and a field electrode dielectric 519. The field electrode 518 is dielectrically insulated from the gate electrode 512. Further, the field electrode 518 is adjacent the channel region 511 and is dielectrically insulated from the channel region 511 by the field electrode dielectric 519. The field electrode 518 is electrically connected to a further control node 54ᵢ of the third transistor 5ᵢ. Like in the embodiment shown in FIG. 9, a doped region of a doping type complementary to the doping type of the source and channel regions 517, 511 may be implemented in at least one of the mesa regions.

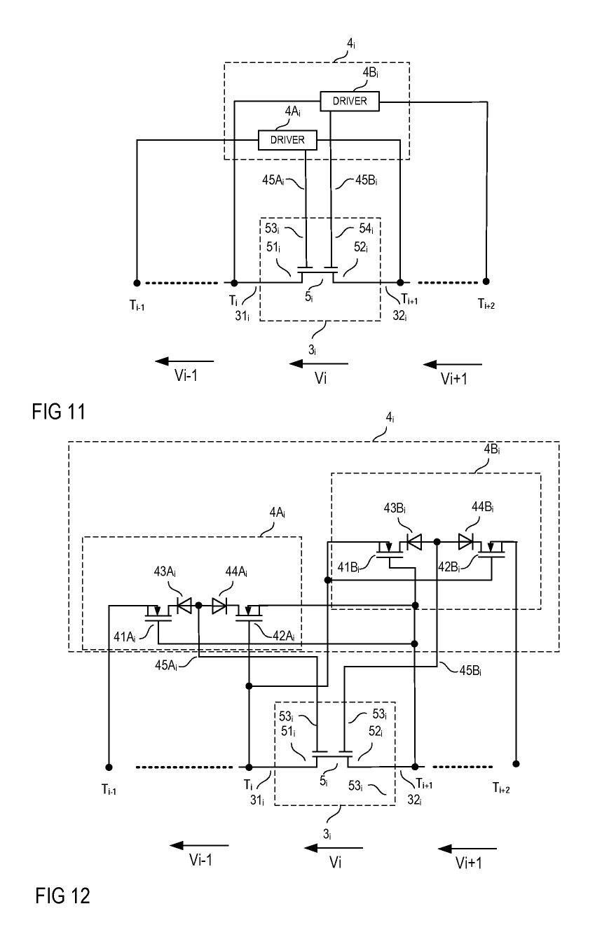

FIG. 11 shows a switch unit 3ᵢ which is implemented with a third transistor 5ᵢ as shown in FIG. 10. Referring to FIG. 11, the drive unit 4ᵢ includes two drivers 4Aᵢ, 4Bᵢ each having a driver output 45Aᵢ, 45Bᵢ, respectively. The driver output 45Aᵢ of the first driver 4Aᵢ is connected to the control node 53ᵢ, which will be referred to as first control node in the following, and the driver output 45Bᵢ of the second driver 4Bᵢ is connected to the second control node 54ᵢ, which will be referred to as second control node in the following. Like the driver 4ᵢ explained before the driver 4ᵢ shown in FIG. 11 is connected to the first and second tap Tᵢ₋₁, Tᵢ₊₁. In this embodiment, in the first supply mode, the first driver 4Aᵢ is configured to connect the drive output 45Aᵢ to the first tap Tᵢ₋₁, and the second driver 4Bᵢ is configured to connect the second drive output 45Bᵢ to the first load node 31ᵢ of the third transistor 5ᵢ. In the second supply mode, the first driver 4Aᵢ is configured to connect its drive output 45Aᵢ to the second load node 32ᵢ, and the second driver 4Bᵢ is configured to connect the second drive output 45Bᵢ to the second tap Tᵢ₊₂. In the first supply mode, the gate electrode 512 (see FIG. 10) controls the operation of the third transistor 5ᵢ in the way explained with reference to FIG. 9 before. In this first supply mode, the field electrode 518 (see FIG. 10) has the electrical potential of the first load node (source node) 51ᵢ and serves to provide counter charges to ionized doping charges in the channel region 511. Those ionized dopant charges occur when the gate electrode 512 pinches of the channel region so that a depletion region expands in the channel region 511 in the direction of the drain region 515. Thus, the field electrode 518 “compensates” dopant charges in the channel region 511 which either increases the voltage blocking capability (of a given on-resistance) or allows to more highly dope the channel region 511 in order to reduce the on-resistance (at a given voltage blocking capability).

In the second supply mode, the gate electrode 512 is connected to the second load node (drain node) 52ᵢ and serves as a field electrode which compensates charge carriers in the channel region 511. In this operation mode, the field electrode 518 acts as the gate electrode which serves to control the channel between the source region 517 and the drain region 515 in the channel region 511.

Referring to FIG. 12 each of the two drivers 4Aᵢ, 4Bᵢ can be implemented with two drive transistors corresponding to the drive transistors 41ᵢ, 42ᵢ shown in FIGS. 6 and 8. FIG. 12 illustrates an embodiment in which each of the two drivers 4Aᵢ, 4Bᵢ is implemented like the drive unit explained with reference to FIG. 6. The first driver 4Aᵢ includes a first drive transistor 41Aᵢ and a second drive transistor 42Aᵢ. A load path of the first drive transistor 41Aᵢ is connected between the first tap Tᵢ₋₁ and the drive output 45Aᵢ, and a load path of the second drive transistor 42Aᵢ is connected between the second load node 32ᵢ and the drive output 45Aᵢ. Equivalently, the second driver 4Bᵢ includes a first drive transistor 41Bᵢ and a second drive transistor 42Bᵢ. A load path of the first drive transistor 41Bᵢ is connected between the first load node 31ᵢ and the drive output 45Bᵢ, and a load path of the second drive transistor 42Bᵢ is connected between the second tap Tᵢ₊₂ and the drive output 45Bᵢ. The first drive transistor 41Aᵢ of the first driver 4Aᵢ receives as a drive voltage the voltage Vi+Vi−1, the second drive transistor 42Aᵢ receives as a drive voltage the voltage Vi. The first drive transistor 41Bᵢ of the second driver 4Bᵢ receives as a drive voltage the voltage Vi, and the second drive transistor 42Bᵢ receives as a drive voltage the voltage Vi+Vi+1.

In the first supply mode, the first transistor 41Aᵢ of the first driver 4Aᵢ, and the first drive transistor 41Bᵢ of the second driver 4Bᵢ are conducting, and the second drive transistors 42Aᵢ, 42Bᵢ are blocking. In the second supply mode, the second drive transistor 42Aᵢ, 42Bᵢ are conducting, while the first drive transistors 41Aᵢ, 41Bᵢ are blocking.

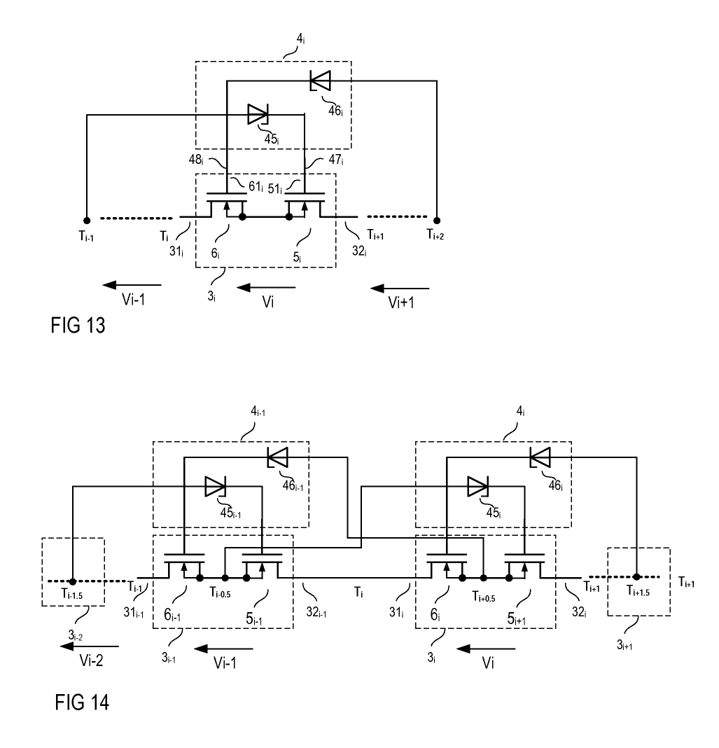

FIG. 13 illustrates another embodiment of a switch unit 3ᵢ and an associated drive unit 4ᵢ. The switch unit 3ᵢ shown in FIG. 13 includes a third transistor 5ᵢ and a fourth transistor 6ᵢ each having a load path and a control node 51ᵢ, 61ᵢ. The load paths of the two transistors 5ᵢ, 6ᵢ are connected in series between the first load node 31ᵢ and the second load node 32ᵢ of the switch unit 3ᵢ. In the embodiment shown in FIG. 13, the third transistor 5ᵢ and the fourth transistor 6ᵢ are each implemented as a MOSFET in particular a depletion MOSFET. These two MOSFETS have their load paths connected in series such that internal body diodes of the MOSFETS are connected back-to-back. For example, the two transistors 5ᵢ, 6ᵢ have the same conductivity type (n-type or p-type) and either have their source nodes connected, or have their drain nodes connected. In the embodiment shown in FIG. 13, the two transistors 5ᵢ, 6ᵢ are implemented as n-type depletion MOSFETs which have their source nodes connected. In the embodiment shown in FIG. 13, the third transistor 5ᵢ is directly connected to the second load node 31ᵢ, and the fourth transistor 6ᵢ is directly connected to the second load node 31ᵢ. However, this is only an example. It is also possible to change the positions of the third and fourth transistor 5ᵢ, 6ᵢ in the switch unit 3ᵢ.

Referring to FIG. 13, the drive unit 4ᵢ includes two drive outputs, a first drive output 47ᵢ connected to the control node 51ᵢ of the third transistor 5ᵢ, and a second drive output 48ᵢ connected to the control node 61ᵢ of the fourth transistor 6ᵢ.

Like the drive units 4ᵢ explained herein before, the drive unit 4ᵢ shown in FIG. 13 is connected to two different taps Tᵢ₋₁, Tᵢ₊₂ of the load path of the electronic circuit 100. These taps are different from the load nodes 31ᵢ, 32ᵢ of the switch unit 3ᵢ associated with the drive unit 4ᵢ. The drive unit 4ᵢ includes a first rectifier element 45ᵢ connected between the first tap Tᵢ₋₁ and the first drive output 47ᵢ, and a second rectifier element 46ᵢ connected between the second tap Tᵢ₊₂ and the second drive output 48ᵢ.

In the embodiment shown in FIG. 13, the first rectifier element 45ᵢ and the second rectifier element 46ᵢ are each implemented as a Zener diode. However, this is only an example, other types of rectifier elements, such as a bipolar diode, a Schottky diode, or the like may be used as well. The first rectify element 45ᵢ is connected such that it keeps the first drive output 47ᵢ substantially on the electrical potential at the first tap Tᵢ₋₁, and the second rectifier element 46ᵢ is connected such that it keeps a second drive output 48ᵢ substantially on the electrical potential at the second tap Tᵢ₊₂. More precisely, the electrical potential at the first drive output 47ᵢ corresponds to the electrical potential at the first tap Tᵢ₋₁ minus a forward voltage of the first rectifier element 45ᵢ, and the electrical potential at the second drive output 48ᵢ corresponds to the electrical potential at the second tap Tᵢ₊₂ minus the forward voltage of the second rectify element 46ᵢ.

One way of operation of the switch unit 3ᵢ and the corresponding drive unit 4ᵢ shown in FIG. 13 is explained in the following. In the first supply mode (P2>P1) the load path voltage Vᵢ of the switch unit 3ᵢ and the load path voltages Vᵢ₋₁, Vᵢ₊₁ of the first and second neighbor have polarities as indicated in FIG. 13. In this operation mode, the electrical potential at the second tap Tᵢ₊₂, in the on-state and the off-state of the electronic circuit 100, is higher than the electrical potential at the source node of the first transistor 6ᵢ, so that the first transistor 6ᵢ is conducting. A drive voltage of the third transistor 5ᵢ substantially corresponds to the negative load path voltage (−Vi−1) of the right neighbor, so that the third transistor 5ᵢ is in the on-state or the off-state dependent on the magnitude of this voltage (−Vi−1). Like the third transistor 5ᵢ explained with reference to FIGS. 6 and 7A, the third transistor 5ᵢ shown in FIG. 13 conducts when the drive voltage is above its threshold voltage, and blocks when the drive voltage is below the threshold voltage. As explained with reference to FIG. 7A the threshold voltage Vth can be a negative voltage.

In the second supply mode, the load path voltage Vi of the switch unit 3ᵢ and Vᵢ₋₁, Vᵢ₊₁ of the first and second neighbor have polarities opposite the polarities indicated in FIG. 13. In this operation mode, the third transistor 5ᵢ is switched on (in the on-state and the off-state of the electronic circuit 100). In this operation mode, the fourth transistor 6ᵢ is controlled by voltage Vi+1. The fourth transistor 6ᵢ is in the on-state, when this voltage is above a negative threshold, and is in the off-state when this voltage is below a negative threshold voltage. The operation of an electronic circuit 100 implemented with a switch unit 3ᵢ and a corresponding drive unit 4ᵢ as explained with reference to FIG. 13 corresponds to the operation explained before.

In the embodiment shown in FIG. 13, the first tap Tᵢ₋₁ is the tap separated from the first load node 31 of the switch unit 3ᵢ by the first neighbor, and the second tap Tᵢ₊₂ is the tap separated from the second load node 32ᵢ of the switch unit 3ᵢ by the second neighbor. However, this is only an example. Referring to FIG. 14, which shows two neighboring switch units 3ᵢ, 3ᵢ₋₁ and the corresponding drive units 4ᵢ, 4ᵢ₋₁, it is also possible to connect the drive unit associated with one switch unit to a tap inside another switch unit. For example, in the embodiment shown in FIG. 14, the drive unit 4ᵢ associated with the switch unit 3ᵢ has the first rectifier element 45ᵢ connected to a tap T_{i-0.5} inside the neighboring switch unit 30 instead of the tap Tᵢ₋₁ corresponding to the first load node 31ᵢ₋₁ of the switch unit 3ᵢ₋₁. The tap T_{i-0.5} inside the switch unit 3ᵢ₋₁ is a circuit node common to the load paths of the third and fourth transistors 5ᵢ₋₁, 6ᵢ₋₁ in the switch unit 3ᵢ₋₁. Equivalently, the second rectifier element 46i in the drive unit 4ᵢ is connected to a tap T_{i+1.5} in the neighboring switch unit 341 (which is only illustrated as dashed box in FIG. 14). The way the second rectifier element 46ᵢ is connected to the tap T_{i+1.5} inside the switch unit 341 corresponds to the way the second rectifier element 46ᵢ₋₁ of the switch unit is connected to tap T_{i+0.5} inside the switch unit 3ᵢ. Using the tap T_{i-0.5} instead of the tap Tᵢ₋₁ makes use of the fact that in the first supply mode, the electrical potentials at these taps T_{i-0.5} and Tᵢ₋₁ are substantially equal.

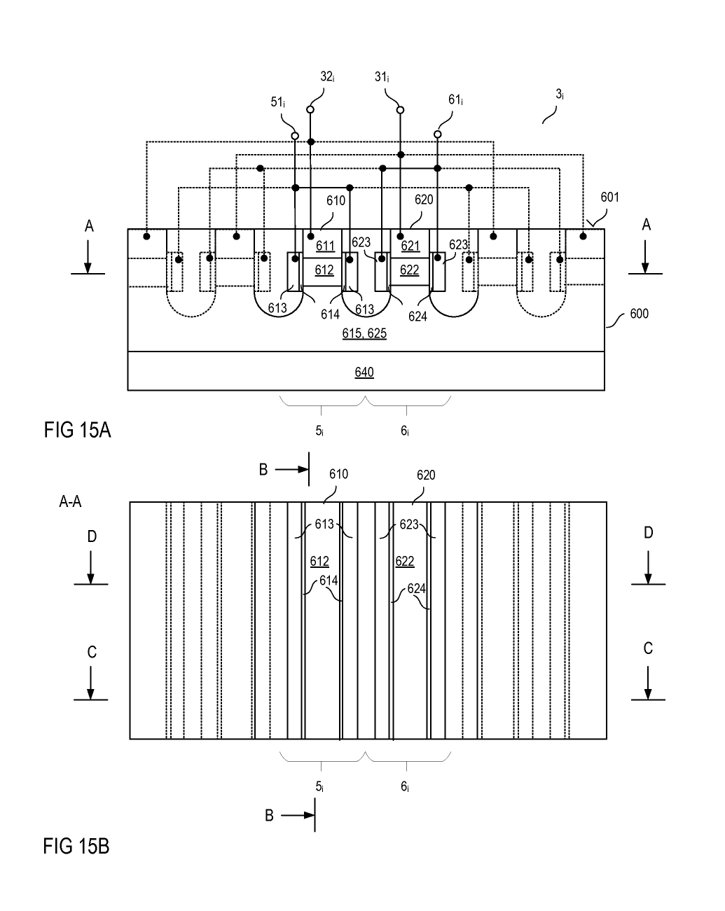

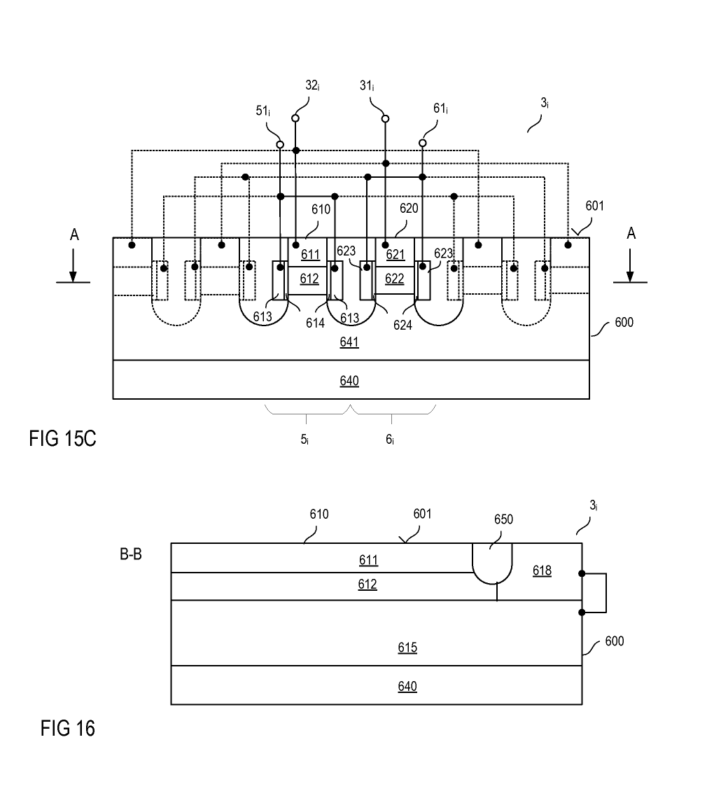

FIGS. 15A-15B show a vertical cross sectional view (FIG. 15A) and a horizontal cross sectional view (FIG. 15B) of a semiconductor body 600 in which a third transistor 5ᵢ and a fourth transistor 6ᵢ of one switch unit 3ᵢ are integrated. The third transistor 5ᵢ, and the second transistor 6ᵢ shown in FIGS. 15A-15B are each implemented as a FINFET. The drain region 611 and a body region 612 adjoining the drain region 611 of the third transistor 5ᵢ are located in a first semiconductor fin 610. The first semiconductor fin 610 is an elongated region of the semiconductor body 600 arranged between two trenches. In each of these two trenches a gate electrode 613 is arranged. The gate electrodes 613 are adjacent the body region 612 and are dielectrically insulated from the body region 612 by a gate dielectric 614. The body region 612 is arranged below the drain region 611 in a vertical direction of the semiconductor body 600 as seen from a first surface 601 of the semiconductor body 600. The “vertical” direction of the semiconductor body 600 is a direction perpendicular to the first surface 601.

A drain region 621 and a body region 622 adjoining the drain region 621 are located in a second semiconductor fin 620 of the semiconductor body 600. The second semiconductor fin 620 is an elongated semiconductor structure between two trenches. In each of these two trenches a gate electrode 623 is arranged. The gate electrode 623 is adjacent the body region 622 and dielectrically insulated from the body region 622 by a gate dielectric 614 and 624. Referring to FIG. 15A, a trench that separates the first semiconductor fin 610 from the second semiconductor fin 620 may include a gate electrode 613 of the third transistor 5ᵢ and a gate electrode 623 of the fourth transistor 6ᵢ. These gate electrodes are electrically insulated from each other.

Referring to FIG. 15A, the third transistor 5ᵢ and the fourth transistor 6ᵢ each have a source region 615 and 625, respectively. These source regions 615, 625 are formed by one semiconductor region which will be referred to as common source region 615/625 in the following. This common source region 615/625 adjoins both the body region 612 of the third transistor 5ᵢ and the body region 622 of the fourth transistor 6ᵢ. The source region 615/625 is arranged below the first and second semiconductor fins 610, 620, however, parts of the source region 630 may extend into these semiconductor fins 610, 620 (as shown in FIG. 15A). Sharing the source region 615/625 by the third transistor 5ᵢ and the fourth transistor 6ᵢ is equivalent to having source nodes of the third transistor 5ᵢ and the fourth transistor 6ᵢ electrically connected, as shown in FIGS. 13 and 14. The drain region 611 of the third transistor 5ᵢ is connected to the second load node 32ᵢ of the switch unit 3ᵢ, and the drain region 621 of the fourth transistor 6ᵢ is connected to the first load node 31ᵢ of the switch unit 3ᵢ. The gate electrodes 613 of the third transistor 5ᵢ are connected to the control node (gate node) 51ᵢ of the third transistor 5ᵢ, and the gate electrodes 614 of the fourth transistor 6ᵢ are connected to the control node (gate node) 61ᵢ of the fourth transistor 6ᵢ.

As shown by dotted lines in FIG. 15A, each of the third transistor 5ᵢ and the second transistor 6ᵢ may include several semiconductor fins, with each of these semiconductor fins including a drain region and a body region of the respective transistor 5ᵢ, 6ᵢ. The gate electrodes of third transistor 5ᵢ are commonly connected to the control load 51ᵢ of the third transistor 5ᵢ, and the gate electrodes and the fourth transistor 6ᵢ are commonly connected to the control node 61ᵢ of the fourth transistor 6ᵢ.

According to one embodiment, the third transistor 5ᵢ and the fourth transistor 6ᵢ are each implemented as a depletion MOSFET. In this case, the drain region 611, 621, the body region 612, 622, and the common source region 615/625 have the same doping type. This doping type is an n-type in an n-type depletion MOSFET, and a p-type in a p-type depletion MOSFET. According to one embodiment, the body regions 612, 622 are doped complementarily to the drain and source regions, but include a channel region of the same doping type as the source and drain regions along the gate dielectric 614, 624.

Referring to FIGS. 15A-15B, the semiconductor body 600 further includes a semiconductor substrate 640 below the common source region 615/625. According to one embodiment, the substrate 640 has a doping type complementary to the doping type of the source region 615/625.

According to one embodiment, the third and fourth transistors 5i, 6i shown in FIGS. 15A-15B, like the transistors shown in FIGS. 9 and 10, include means which prevent minority charge carriers from accumulating in the body regions 612, 622. One embodiment of such means is illustrated in FIG. 15C. FIG. 15C shows a vertical cross sectional view of the semiconductor body 600 in a section plane D-D. Referring to FIG. 15B, section plane D-D is spaced apart from section plane C-C illustrated in FIG. 15A.

Referring to FIG. 15C, there are sections of the semiconductor body 600 where a semiconductor region 641 is arranged between the substrate 640 and the body regions 612, 622. This semiconductor region 614 has the same doping type as the substrate 640, wherein the substrate 640 and this region 641 have a doping type complementary to the doping type of the body regions 612, 622. In this embodiment, the region 641 serves to “collect” minority charge carriers that may be occur in the body regions 612, 622. This region 641 and/or the substrate is ohmically connected to the source region 615/625 in this embodiment. Such ohmic connection can be obtained by connecting the region 641 and/or the substrate to the source region 615/625 through a metal (not shown in FIG. 15C).

Additionally to the means explained with reference to FIG. 15C, or alternatively to these means, the body regions 612, 622 may have sections which spaced apart from the source regions 611, 662 extend in the direction of the surface 601 of the semiconductor body 600. This is explained with reference to FIG. 16, which illustrates a vertical cross sectional view in a longitudinal direction of the first semiconductor fin 610. Referring to FIG. 16, the body region 612 adjoins a doped region 618 of a doping type complementary to the doping type of the body region 612. This doped region 618 is ohmically connected to the source region 615. Such connection, which is only schematically shown in FIG. 16, may include a metal region at the interface between the source region 615 and the doped region 618.

Referring to FIG. 16, the doped region 618 is electrically insulated from the drain region 611 by an insulation layer 650. The insulation layer 650 is arranged in a trench that extends from the first surface into the body region 612. Along this trench the doped region 618 may extend to the first surface 101.

A region corresponding to the doped region 618 and a region corresponding to the insulation region 650 may be provided in the second semiconductor fin 620 of the third transistor 5ᵢ to prevent an accumulation of charge carriers in the body region 622 in the second semiconductor fin 620. Each of the semiconductor fins 610, 620 may include one or more of these regions 618 that prevent the accumulation of charge carriers. If one semiconductor fin includes two or more of these regions 618, these regions are spaced apart in a longitudinal direction of the semiconductor fin. These optional regions 618 are not shown in FIG. 15B.

In the embodiment shown in FIG. 15A-15B, the first and second semiconductor FIN 610, 620 are substantially parallel and are separated by a trench which substantially extents parallel to the first and second semiconductor FIN 610, 620. In other words, the first semiconductor FIN 610 and the second semiconductor FIN 620 are distant in a direction perpendicular to longitudinal directions of the first and second semiconductor FIN 610, 620.

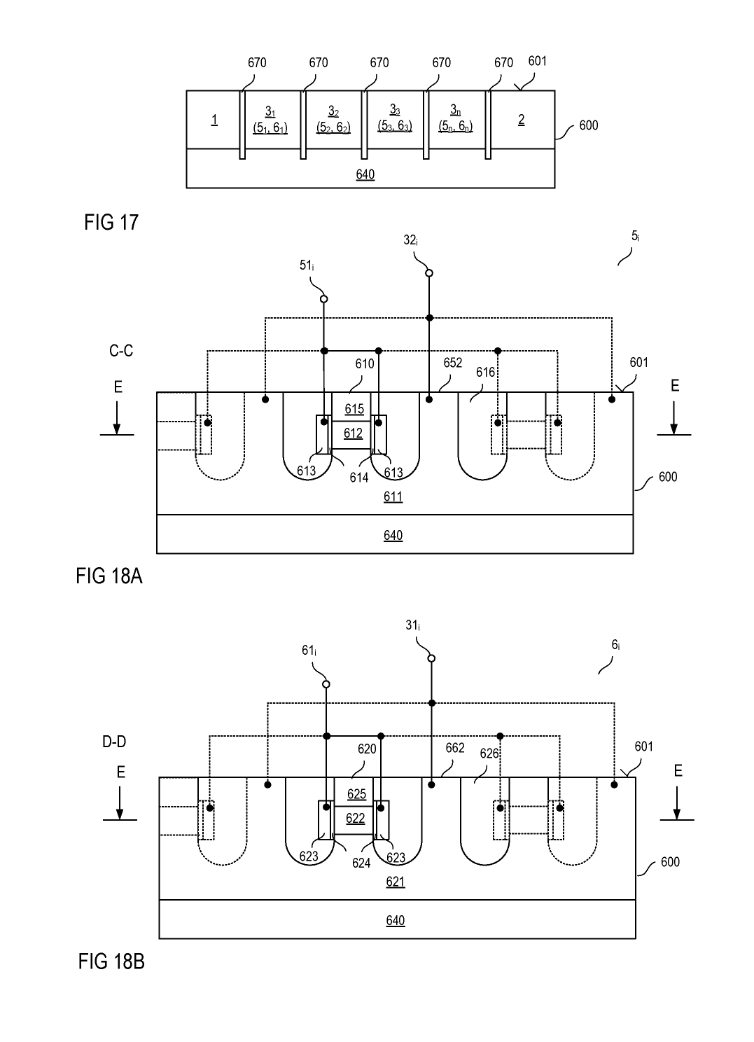

FIG. 17 illustrates a vertical cross sectional view of a semiconductor body 600 in which the first electronic switch 1, the second electronic switch 2 and the plurality of switch units 3₁-3ₙ with each switch unit 3₁-3ₙ including a third transistor 5₁-5ₙ and a fourth transistor 6₁-6ₙ are integrated. Each of the switch units 3₁-3ₙ can be implemented as explained with reference to FIGS. 15A-15B herein before. In FIG. 17 only semiconductor regions above the substrate 640 are shown in which these switch units 3₁-3ₙ are integrated. These semiconductor regions are separated by dielectric layers 670 which extent from the first surface 601 into the semiconductor substrate. The first electronic switch 1 and the second electronic switch 2 can be implemented in a conventional way. According to one embodiment, these semiconductor switches 1, 2 are implemented as FINFETs.

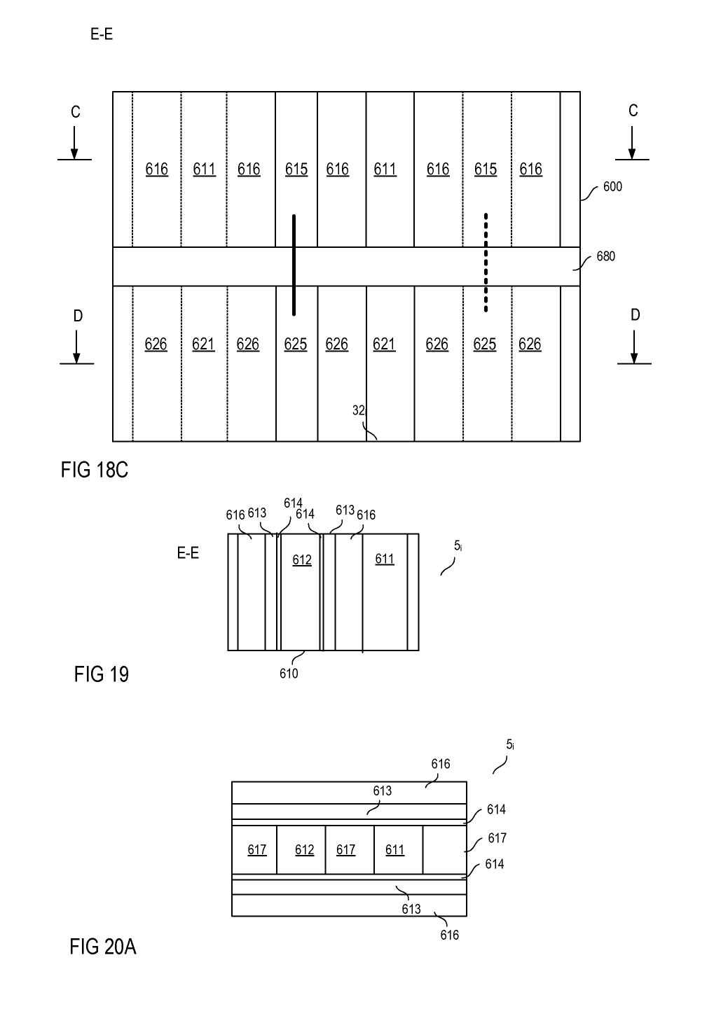

FIGS. 18A-18C show another embodiment for implementing a switch unit with a third transistor 5ᵢ and a second transistor 6ᵢ. FIG. 18A shows a vertical cross sectional view of the semiconductor body 600 in a region in which the third transistor 5ᵢ is integrated, FIG. 18B shows a vertical cross sectional view of the semiconductor body 600 in a region in which the fourth transistor 6ᵢ is integrated, and FIG. 18C shows a horizontal cross sectional view of the semiconductor body 600. Third transistor 5ᵢ shown in FIG. 18A is implemented as a FINFET which is different from the FINFET shown in FIG. 15A in that the source region 615 and the body region 612 are arranged in the first semiconductor FIN 610 and that the drain region 611 extents to the first surface 601 adjacent the two trenches which form the first semiconductor fin 610. The drain region 611 is connected to the second load node 32ᵢ at the first surface 601.

In the fourth transistor 6ᵢ shown in FIG. 18B, the source region 625 and the body region 622 are arranged in the second semiconductor fin 620. The drain region 621 adjoins the body region 622 and extends to the first surface 601 adjacent the two trenches which form the second semiconductor fin 620. At the first surface 601 the drain region 621 is connected to the first load node 31ᵢ. Like in the embodiment explained with reference to FIGS. 15A-15B each of the third transistor 5ᵢ and the fourth transistor 6ᵢ may include several semiconductor fins 610, 620, respectively. Each of these semiconductor fins is part of a transistor cell, wherein the individual transistor cells are connected in parallel by having the gate electrodes 613, 623, respectively, connected to the respective control node 51ᵢ, 61ᵢ, and by having the individual drain regions 611, 621 connected to the respective load node 32ᵢ, 31ᵢ, respectively.

Referring to FIG. 18C, the region in which the third transistor 5ᵢ is integrated is electrically insulated from the region in which the fourth transistor 6ᵢ is integrated by an insulation region 680. The insulation region 680 may, for example, include an electrically insulating or a dielectrically insulating material. Referring to FIG. 18C, the source region 615 of the third transistor 5ᵢ, and the source region 625 of the fourth transistor 6ᵢ are electrically connected. Such electrical connection is only schematically illustrated by a bold line in FIG. 18C. The electrical connection may include a conventional material such as, for example, a metal.

In the embodiment shown in FIGS. 18A-18B, the gate electrodes 613, 623 extent substantially parallel to the body regions 612, 622. This is illustrated in detail for the third transistor 5ᵢ in FIG. 19. FIG. 19 shows a vertical cross sectional view of one section of the semiconductor body 600 in a region in which the third transistor 5ᵢ is integrated. In this embodiment, the body regions 612, 622 are integrated in elongated semiconductor fins 610.

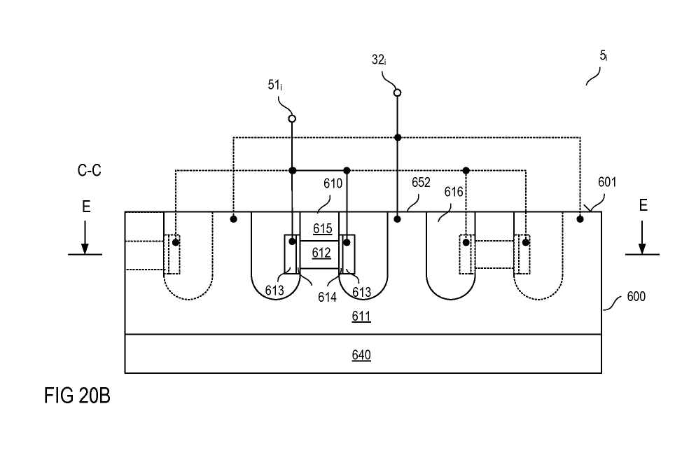

FIG. 20A shows a horizontal cross sectional view in a section plane corresponding to section plane E-E shown in FIG. 19 of a region of the semiconductor body 600 in which a third transistor 5ᵢ according to another embodiment is implemented. In this embodiment, the body region 612 (and the source region 615, which is out of view in FIG. 20) are arranged in a pile-shaped semiconductor region. Like in the embodiment shown in FIG. 18A, the drain region 611 extends to the first surface of the semiconductor body 600. The sections of the drain region 611 which extend to the first surface 601 are electrically insulated from the source and body region 615, 612 by a trench filled with an electrically insulating or dielectrically insulating material 617. The body region 612 and the section of the drain region 611 extending to the first surface 601 are distant in a first direction. The gate electrode 613 is arranged in a trench which adjoins the body region 612 in a second direction which is perpendicular to the first direction. Like in the embodiment explained with reference to FIG. 18C, the source regions 615 of the third transistor 5ᵢ are electrically connected with corresponding source regions of the third transistor 6ᵢ. This fourth transistor 6ᵢ can be implemented in the same way as the third transistor 5ᵢ shown in FIG. 20A-20B.

According to one embodiment, at least one switch unit 3ᵢ and the corresponding drive unit 4ᵢ are monolithically integrated in one semiconductor body (die). For this, it may be necessary to dielectrically insulate those regions of the semiconductor body where the switch unit 3ᵢ is integrated from those regions of the semiconductor body where the drive unit 4ᵢ is integrated. Such region for integrating the drive unit 4ᵢ will be referred to as dielectrically insulated region in the following.

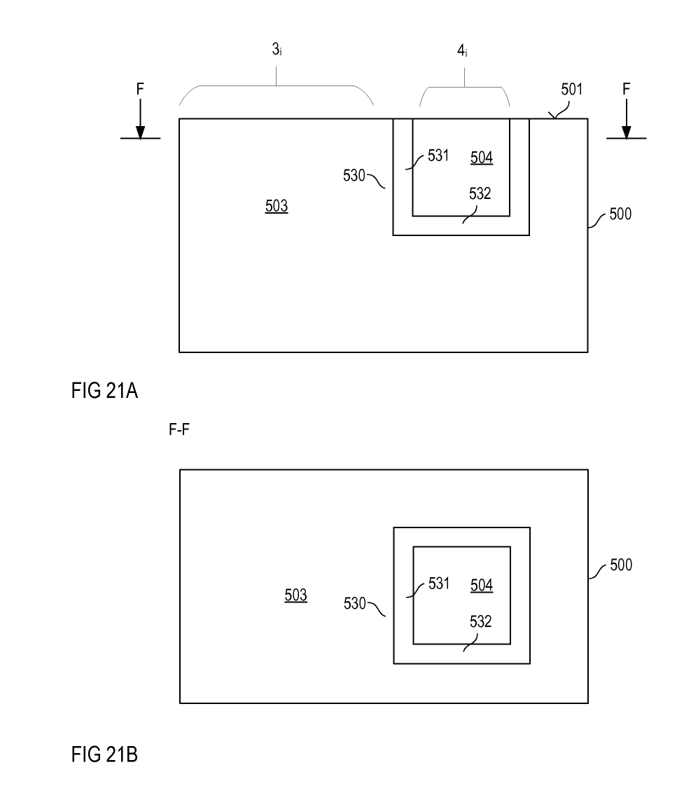

FIGS. 21A and 21B schematically illustrate one embodiment of the semiconductor body 500 that includes an dielectrically insulated region. FIG. 21A shows a vertical cross sectional view and FIG. 21B shows a top view of the semiconductor body 500. In these figures, reference character 503 denotes a first region of the semiconductor body 500 where the switch unit 3ᵢ can be implemented and reference character 504 denotes a second region where the drive unit can be implemented. The second region 504 is a dielectrically insulated region. The drive unit 3ᵢ, that is, the third transistor 5ᵢ and the optional fourth transistor 6ᵢ, can be implemented in accordance with any of the embodiments explained herein before. However, details of the switch unit 3ᵢ are not shown in FIGS. 21A and 21B. The drive unit 4ᵢ can be implemented in accordance with any of the embodiments explained herein before. The individual devices of the drive unit 4ᵢ, such as the diodes or transistors explained before, are integrated in the semiconductor region 504. However, details of the drive unit 4ᵢ are not shown in FIGS. 21A and 21B.

The second region 504 is dielectrically insulated from the first region 503 by a well-like dielectric region 530. This dielectric region 530 includes a bottom section 532 and a sidewall section 531. The sidewall section 531 extends from the bottom section 532 to the first surface 501 and surrounds the second region 504 so that the well-like dielectric region completely separates the second region 504 from the first region 503 in the semiconductor body 500. The dielectric region may include a conventional dielectric material such as, for example, an oxide, a nitride, or the like. According to one embodiment, the well-like structure 530 does not extend to a second surface opposite the first surface 501 of the semiconductor body 500. A size of the well-like structure can be selected dependent on the space required to implement the drive unit 4ᵢ.

In the embodiment shown in FIG. 21B, the sidewall section 53, in a horizontal plane of the semiconductor body 500, is substantially rectangular. However, this is only an example. The sidewall section 531 may be implemented with another shape, such as a circular shape, an elliptical shape or a polygonal shape, as well. The bottom section 532 has a shape adapted to the shape of the sidewall section 531.

The drive unit 4ᵢ in the second region 504 and the switch unit 3ᵢ in the first region 503 can be interconnected by a wiring arrangement on top of the first surface 501. However such wiring arrangement is not shown in FIGS. 21A and 21B.

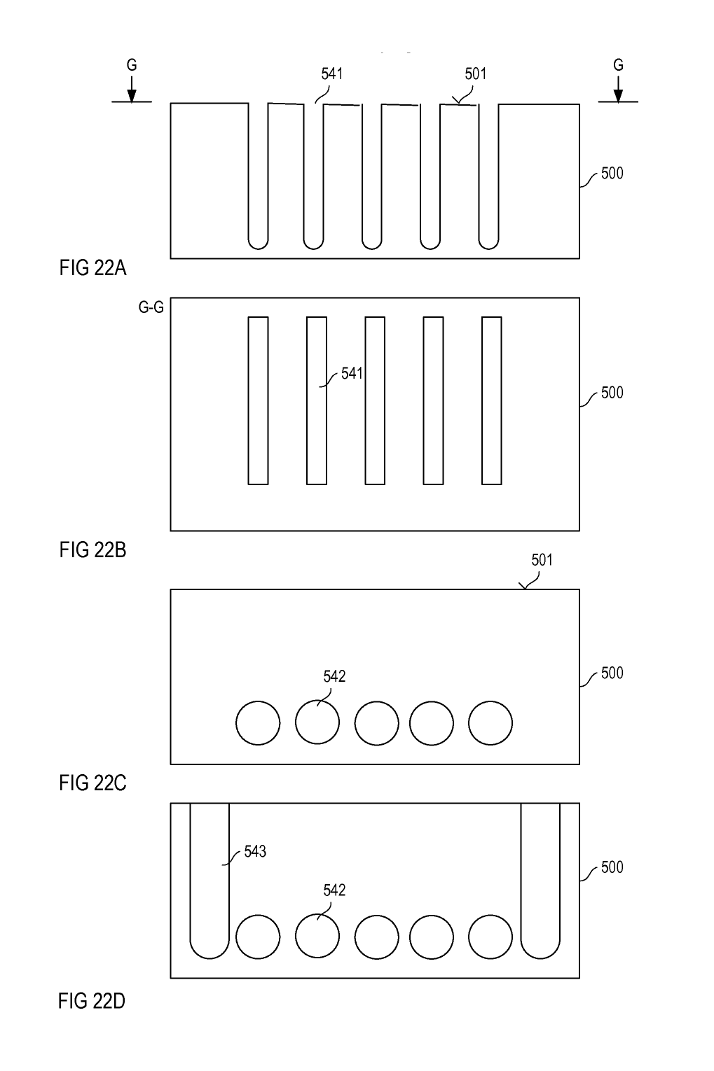

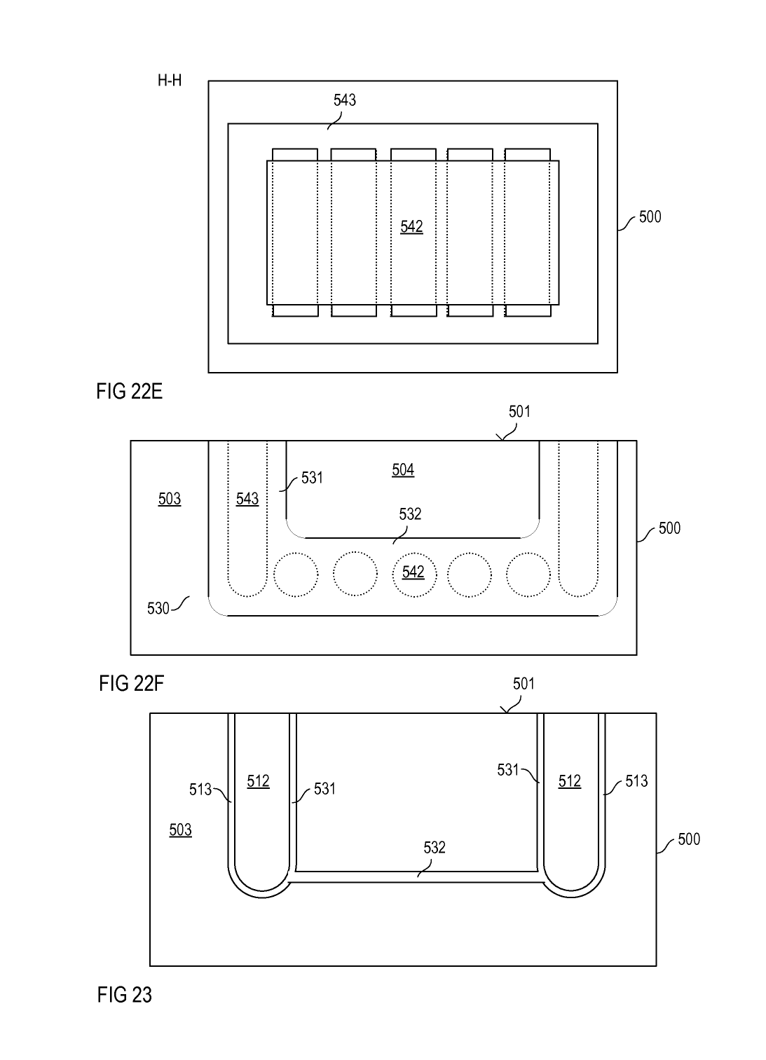

FIGS. 22A-22F illustrate one embodiment of a method for producing a well-like dielectric region 530 as shown in FIGS. 21A and 21B. In these FIGS. 22A-22F only a section of the semiconductor body 500 is shown where the dielectric well 530 is implemented.

Referring to FIG. 22A, which shows vertical cross sectional view of the semiconductor body 500, and FIG. 22B, which shows a top view of the semiconductor body, the method includes forming a plurality of trenches 541 that extend from the first surface 501 into the semiconductor body 500. These trenches 541 are spaced apart in a first horizontal direction of the semiconductor body 500. In the embodiment shown, the trenches 541 are elongated trenches that are substantially parallel.

Based on these trenches 541 voids 542 are formed spaced apart from the first surface 501. These voids are shown in FIG. 22C, which shows a vertical cross sectional view of the semiconductor body 500. Forming these voids 542 may include tempering the semiconductor body 500 in a hydrogen containing atmosphere at temperatures of more than about 1000° C. The pressure in this process may be atmospheric pressure or below atmospheric pressure. The hydrogen containing atmosphere may be a pure hydrogen atmosphere, or an atmosphere including a gas mixture of hydrogen and inert gases. In this process, silicon along the sidewalls of the trenches 541 rearranges so as to form the voids 542 below the first surface 501.

According to one embodiment, the trenches 541 are designed such that a distance of these trenches 541 is such that after the tempering process the voids 542 are spaced apart. That is, there is a semiconductor region between the individual voids 542. These semiconductor regions will be referred to as semiconductor bridges in the following.

Referring to FIG. 22D, which shows a vertical cross sectional view of the semiconductor body 500, and FIG. 22E, which shows a top view of the semiconductor body 500, the method includes forming a further trench 543. This further trench 543 is ring shaped in the horizontal plane and extends from the first surface 501 down to the voids 542 such that the further trench 543 “opens” the voids 542 at least at one longitudinal end. Referring to FIG. 22E, the ring-shaped trench 543 may open each of the plurality of voids 542 at both of its opposite longitudinal ends. At those sides where the further trench 543 runs parallel to the voids 542 (see FIG. 22D) the further trench may be spaced apart from the two outermost voids. According to another embodiment (not shown) the further trench 543 opens the outermost trenches also along their respective longitudinal direction.

After forming the further trench 543, the method further includes tempering the semiconductor body 500 in an oxidizing atmosphere. In this process, sidewalls of the voids 542 and of the further trench 543 are oxidized in order to form an oxide as the dielectric of the dielectric well 530. In particular, oxidizing the sidewalls of the voids 542 and the further trench 543 includes oxidizing the semiconductor bridges between the voids 542 and between the outermost voids and the further trench 543, if there is a semiconductor bridge between the outermost voids 542 and the further trench 543. This oxidizing process results in a contiguous dielectric well 530 with the bottom section 532 and the sidewall section 531 shown in FIG. 22F. In FIG. 22F, the former voids 542 and the former further trench 543 are shown in dotted lines. Oxidizing the sidewalls of the voids 542 and the further trench 543 may include completely filling the voids 542 and the further trench 543 with the oxide (as shown). Alternatively, oxidizing the sidewalls may include leaving smaller residual voids (not shown). In each case, the semiconductor bridges are completely oxidized so as to form the contiguous dielectric well 530 that separates the second region 504 from the first region 503.

Referring to FIGS. 9 and 10, for example, the drive unit 3ᵢ may include a trench transistor with at least one gate electrode 512, 518 arranged in a trench. According to one embodiment, the further trench 543 explained with reference to FIGS. 22D and 22E is formed in the same process in which the trench of the at least one gate electrode 512, 518 is formed, and the oxidizing process explained with reference to FIG. 22F can be the same oxidizing process in which the gate dielectric 513, 519 is formed. In this oxidizing process, the gate dielectric 513, 519 does not completely fill the trench, but the at least one gate electrode is formed in the (further) trench. FIG. 23 shows a vertical cross sectional view of a dielectric well 530 formed by such process. As can be seen from FIG. 23, the further trench includes a gate electrode 512. The gate dielectric 513 along the sidewall of the trench that faces the second region 504 forms the sidewall section of the dielectric well.

In the embodiment shown in FIG. 23 there is only one gate electrode 512 in the trench. However, this is only an example. In the way shown in FIG. 10 two gate electrodes 512, 518 may be implemented as well. The gate electrode 512 in the trench of the dielectric well 530 may be used to control a conducting channel in those regions of the first region 503 adjoining the gate dielectric 513. In the way explained with reference to FIG. 10 source and body regions may be implemented in those regions adjoining the gate dielectric 513.

In the description hereinbefore, directional terminology, such as “top,” “bottom,” “front,” “back,” “leading,” “trailing” etc., is used with reference to the orientation of the figures being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. Features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

As used herein, the terms “having,” “containing,” “including,” “comprising” and the like are open ended terms that indicate the presence of stated elements or features, but do not preclude additional elements or features. The articles “a,” “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. An electronic circuit, comprising:
a first electronic switch comprising a load path and a control node;
a second electronic switch comprising a load path and a control node;
a plurality of switch units, each comprising a load path between a first load node and a second load node; and
a plurality of drive units,
wherein the load path of the first electronic switch, the load path of the second electronic switch, and the load paths of the plurality of switch units are connected in series to form a load path of the electronic circuit,
wherein a series circuit with the load paths of the plurality of switch units is connected between the load path of the first electronic switch and the load path of the second electronic switch,
wherein the load path of the electronic circuit comprises a plurality of taps,
wherein each drive unit is associated with one of the plurality of switch units, is coupled to at least two different taps of the plurality of taps, and is configured to drive the associated switch unit based on an electrical potential at one of the at least two different taps.

2. The electronic circuit of claim 1,
wherein the two different taps are different from the first load node and the second load node of the associated switch unit.

3. The electronic circuit of claim 2,
wherein the associated switch unit has a first neighbor connected to the first load node of the associated switch unit, and a second neighbor connected to the second load node of the associated switch unit,
wherein the first neighbor is selected from the first electronic switch, the second electronic switch, and one of the plurality of switch units different from the associated switch unit,
wherein the second neighbor is selected from the first electronic switch, the second electronic switch, and one of the plurality of switch units different from the associated switch unit,
wherein a first tap of the two different taps is one of the first and second load nodes of the first neighbor, and
wherein a second tap of the two different taps is one of the first and second load nodes of the second neighbor.

4. The electronic circuit of claim 2,
wherein the associated switch unit has a first neighbor connected to the first load node, and a second neighbor connected to the second load node,
wherein the first neighbor is selected from the first electronic switch, the second electronic switch, and one of the plurality of switch units different from the associated switch unit,
wherein the second neighbor is selected from the first electronic switch, the second electronic switch, and one of the plurality of switch units different from the associated switch unit,
wherein a first tap of the two different taps is a tap inside the first neighbor, and
wherein a second tap of the two different taps is a tap inside the second neighbor.

5. The electronic circuit of claim 4,
wherein the first neighbor comprises two controllable electronic switching devices connected in series, and the second neighbor comprises two controllable electronic switching devices connected in series, and
wherein the first tap is a circuit node common to the two controllable electronic switching devices of the first neighbor, and the second tap is a circuit node common to the two controllable electronic switching devices of the second neighbor.

6. The electronic circuit of claim 1, wherein at least one of the associated switch units comprises at least one controllable electronic switching device.

7. The electronic circuit of claim 6, wherein the at least one controllable electronic switching device is selected from the group consisting of:
a depletion MOSFET;
a JFET;
a HEMT; and
a nanotube.

8. The electronic circuit of claim 6, wherein at least one of the associated switch units comprises two controllable electronic switching devices connected in series.

9. The electronic circuit of claim 1,
wherein at least one of the associated drive units comprises a first controllable electronic switch coupled to a first tap of the two different taps, and a second controllable electronic switch coupled to a second tap of the two different taps,
wherein the first controllable electronic switch is configured to drive the associated drive unit based on an electrical potential at a tap different from the first tap and the second tap, and
wherein the second controllable electronic switch is configured to drive the associated drive unit based on an electrical potential at a tap different from the first tap and the second tap.

10. The electronic circuit of claim 9,
wherein at least one of the associated drive units comprises a first rectifier element connected in series with a load path of a first one of the two controllable electronic switching devices, and a second rectifier element coupled in series with a load path of a second one of the two controllable electronic switching devices.

11. The electronic circuit of claim 8,
wherein the at least one of the associated drive units comprises a first rectifier element coupled between a load node of one of the two electronic switches and one of the at least two different taps, and a second rectifier element coupled between a load node of another one of the two electronic switches and another one of the at least two different taps.

12. The electronic circuit of claim 11,
wherein at least one of the first and second rectifier elements comprises a Zener diode.

13. The electronic circuit of claim 11,
wherein each of the first electronic switch and the second electronic switch comprises a transistor, and
wherein the transistor of the first electronic switch and the transistor of the second electronic switch are transistors of the same type.

14. The electronic circuit of claim 13,
wherein each of the transistors of the first electronic switch and the second electronic switch comprises an internal diode, and
wherein the first electronic switch and the second electronic switch are connected such that these diodes are connected back-to-back.

15. The electronic circuit of claim 1,
wherein at least one of the plurality of switch units comprises a transistor with a first gate and a second gate.

16. The electronic circuit of claim 15, wherein the first gate and the second gate are implemented in a common trench of a semiconductor body.

17. The electronic circuit of claim 1, wherein at least one of the plurality of switch units comprises at least one transistor implemented as a FINFET.

18. The electronic circuit of claim 17, wherein the at least one of the plurality of switch units comprises two transistors each implemented as a FINFET.

19. The electronic circuit of claim 1, wherein the first electronic switch, the second electronic switch and the plurality of switch units are implemented in a common semiconductor body.

20. The electronic circuit of claim 1, wherein at least one of the plurality of switch units and the associated drive unit are implemented in a common semiconductor body.
